(19) United States
(12) Patent Application Publication
(10) Pub. No.: US 2024/0092212 A1
(43) Pub. Date: Mar. 21, 2024

(54) ENHANCED ELECTRIC VEHICLE CHARGING AND CHARGING RESERVATION

(71) Applicant: Complx Inc., Wimauma, FL (US)

(72) Inventors: Joshua Burton, Wimauma, FL (US); Steven MacFarlane, Bradenton, FL (US); Matthew Vergin, St. Petersburg, FL (US); Robert Brady, Sarasota, FL (US)

(73) Assignee: Complx Inc., Wimauma, FL (US)

(21) Appl. No.: 18/467,856

(22) Filed: Sep. 15, 2023

Related U.S. Application Data
(60) Provisional application No. 63/407,080, filed on Sep. 15, 2022.

(51) Int. Cl. B60L 53/63; B60L 53/65; B60L 53/67; G06Q 10/02

(52) U.S. Cl. CPC B60L 53/63; B60L 53/65; B60L 53/67; G06Q 10/02; B60L 2250/00

(57) ABSTRACT

This disclosure describes systems, methods, and devices related to reserving electric vehicle charging ports. A method may include receiving, by a device of an electric vehicle charging bank, from a management system, a first indication of an application-originated request to reserve the electric vehicle charging bank; receiving charging data, from the electric vehicle charging bank, which indicate that a first electric vehicle charging station of the electric vehicle charging bank is available for charging an electric vehicle; sending to the management system, the charging data; receiving, from the management system, a third indication of an application-originated reservation of the first electric vehicle charging station; determining, based on the charging data, an amount of amperage to distribute to the first electric vehicle charging station for the application-originated reservation; and send, to the electric vehicle charging bank, an instruction to distribute the amount of amperage to the first electric vehicle charging station.

### CROSS-REFERENCE TO RELATED APPLICATION(S)

This application claims the benefit of U.S. Provisional Application No. 63/407,080, filed Sep. 15, 2022, the disclosure of which is incorporated herein by reference as if set forth in full.

### TECHNICAL FIELD

Embodiments of the present invention generally relate to systems and methods for electric vehicle charging.

### BACKGROUND

Electric vehicles are becoming more widely used, and the need for electric vehicle charging stations is increasing. Electric vehicle drivers may need assistance in finding and using available electric vehicle charging stations, and electric vehicle charging stations may need to accommodate multiple vehicles at different times.

### SUMMARY

A method for reserving electric vehicle charging stations may include causing presentation, by at least one processor of a first device, of a mobile application at a second device; receiving, by the at least one processor, a first user request from the mobile application to identify an available electric vehicle charging station; identifying, by the at least one processor, a first available electric vehicle charging station; causing presentation, by the at least one processor, of an indication of the first available electric vehicle charging station at the second device, using the mobile application; receiving, by the at least one processor, a second user request from the mobile application to reserve the first available electric vehicle charging station; and sending, by the at least one processor, based on the second user request, a command to the first available electric vehicle charging station to reserve the first available electric vehicle charging station for a user from which the second user request was received.

A system for reserving electric vehicle charging stations may include electric vehicle charging stations; and memory coupled to at least one processor of a first device, the at least one processor configured to: cause presentation of a mobile application at a second device; receive a first user request from the mobile application to identify an available electric vehicle charging station of the electric vehicle charging stations; identify a first available electric vehicle charging station of the electric vehicle charging stations; cause presentation of an indication of the first available electric vehicle charging station at the second device, using the mobile application; receive a second user request from the mobile application to reserve the first available electric vehicle charging station; and send, based on the second user request, a command to the first available electric vehicle charging station to reserve the first available electric vehicle charging station for a user from which the second user request was received.

A device for reserving electric vehicle charging stations may include memory coupled to at least one processor of a device, the at least one processor configured to: cause presentation of a mobile application at a second device; receive a first user request from the mobile application to identify an available electric vehicle charging station; identify a first available electric vehicle charging station; cause presentation of an indication of the first available electric vehicle charging station at the second device, using the mobile application; receive a second user request from the mobile application to reserve the first available electric vehicle charging station; and send, based on the second user request, a command to the first available electric vehicle charging station to reserve the first available electric vehicle charging station for a user from which the second user request was received.

A method for distributing power to multiple electrical vehicles using charging ports at a charging station may include detecting a number of electrical vehicles concurrently connected to charging ports of a charging station, wherein the charging ports are serially connected; dividing an available amperage of the charging station by the number of electrical vehicles to generate a first respective amperage to distribute to each of the electrical vehicles via the charging ports; identifying a user request to boost the first respective amperage distributed to a first electrical vehicle of the number of electrical vehicles, via a first charging port of the charging ports, to a first amperage above the first respective amperage; subtracting the first amperage from the available amperage to generate a remaining available amperage in addition to the first amperage; dividing the remaining available amperage of the charging station by the number of electrical vehicles minus the first electrical vehicle to generate a second respective amperage to distribute to each of the electrical vehicles, except the first electrical vehicle, via the charging ports except for the first charging port; and distributing the first amperage to the first charging port while distributing the second respective amperage to the charging ports except for the first charging port.

A retractable electrical vehicle charging device, wherein a cable of the retractable electrical vehicle charging device is configured to retract while a button on a handle of the retractable electrical vehicle charging device is pressed.

A retractable electrical vehicle charging device, wherein a cable of the retractable electrical vehicle charging device is configured to retract when a handle of the retractable electrical vehicle charging device is docked.

A retractable electrical vehicle charging device comprising a sensor and at least one processor, wherein the at least one processor is configured to: detect when a handle of the retractable electrical vehicle charging device has not been connected to a vehicle for a period of time; and cause a cable of the retractable electrical vehicle charging device to retract based on the detection.

### BRIEF DESCRIPTION OF THE DRAWINGS

FIG. 1 illustrates example mobile application interfaces for reserving electric vehicle (EV) charging stations in accordance with one embodiment.

FIG. 2 illustrates example mobile application interfaces for purchasing EV charging in accordance with one embodiment.

FIG. 3 illustrates example EV charging displays in accordance with one embodiment.

FIG. 4 illustrates example EV charging bank in accordance with one embodiment.

FIG. 5 illustrates an example system for verifying a user of an EV charging station in accordance with one embodiment.

FIG. 6 illustrates example EV charging bank power distribution in accordance with one embodiment.

FIG. 7 illustrates the EV charging bank of FIG. 6 distributing power to multiple EVs in accordance with one embodiment.

FIG. 8 illustrates the EV charging bank of FIG. 6 distributing power to multiple EVs in accordance with one embodiment.

FIG. 9 illustrates the EV charging bank of FIG. 6 distributing power to multiple EVs in accordance with one embodiment.

FIG. 10 illustrates the EV charging bank of FIG. 6 distributing power to multiple EVs in accordance with one embodiment.

FIG. 11 illustrates example EV charging bank power distribution in accordance with one embodiment.

FIG. 12 illustrates an example EV charging bank power distribution in accordance with one embodiment.

FIG. 13 illustrates the example EV charging bank of FIG. 12 distributing power to multiple EVs in accordance with one embodiment.

FIG. 14 illustrates the example EV charging bank of FIG. 12 distributing power to multiple EVs in accordance with one embodiment.

FIG. 15 illustrates the example EV charging bank of FIG. 12 distributing power to multiple EVs in accordance with one embodiment.

FIG. 16 illustrates the example EV charging bank of FIG. 12 distributing power to multiple EVs in accordance with one embodiment.

FIG. 17 illustrates example EV charging bank power distribution in accordance with one embodiment.

FIG. 18 illustrates example EV charging bank power distribution in accordance with one embodiment.

FIG. 19A illustrates an example EV charger in accordance with one embodiment.

FIG. 19B illustrates example EV chargers with separate casting in accordance with one embodiment.

FIG. 19C illustrates example EV chargers with shared casting in accordance with one embodiment.

FIG. 20 illustrates an example EV charger in accordance with one embodiment.

FIG. 21 illustrates example EV charger environments in accordance with one embodiment.

FIG. 22 illustrates example EV charger mounting systems in accordance with one embodiment.

FIG. 23 illustrates an example EV charger retraction in accordance with one embodiment.

FIG. 24 illustrates an example EV charger retraction in accordance with one embodiment.

FIG. 25 illustrates an example EV charger retraction in accordance with one embodiment.

FIG. 26 illustrates the EV charger for winding the cable of FIG. 23 in accordance with one embodiment.

FIG. 27 illustrates an example system for reserving and operating EV charging stations in accordance with one embodiment.

FIG. 28A is a flowchart illustrating a process for reserving and using an EV charging station in accordance with one embodiment.

FIG. 28B is a flowchart illustrating a process for reserving and using an EV charging station in accordance with one embodiment.

FIG. 29 is a diagram illustrating an example of a computing system that may be used in implementing embodiments of the present disclosure.

### DETAILED DESCRIPTION

Aspects of the present disclosure involve systems, methods, and the like, for enhancing electric vehicle chargers and reserving electric vehicle charging stations.

As the use of electric vehicles (EVs) increases, so does the need for EV charging stations. EV drivers may need assistance in finding nearby EV charging stations, particularly those with availability. However, even if an EV charging station is available when an EV driver identifies it, the EV charging station may become unavailable by the time the EV arrives (e.g., because another EV may arrive first to use the EV charging station).

EV charging stations also may need to distribute power concurrently to multiple EVs at a time based on an available power and existing load on the grid, with the demand varying based on the number of vehicles concurrently using a charging station and the amount of charge needed per vehicle. Some EV users may demand more power to more quickly charge their EVs at a given time than other EV users at a charging location.

EV drivers may need assistance in estimating how long their EV may take to charge, and the charging time may vary based on factors such as the current charge of an EV battery and the electrical load being consumed concurrently by other vehicles at a charging station, the available power at the charging location, and the load on the grid.

In one or more embodiments, a mobile application may facilitate EV charging station reservations and payments. A user may identify an EV charging station with the mobile application, which may indicate whether there is an available charging station or will be an available charging station within an amount of time. EV drivers may reserve an available charging station for a period of time so that the EV drivers do not need to wait (at least longer than a time presented to the user via the mobile application) for an available charging station. The mobile application may allow for pre- and post-payment of EV charging stations, user/EV customization, notifications regarding available charging stations, prices, etc., and vehicle registration. The number of reservations allowed at a given charging station may be capped, and the cap may vary based on the time of day, time of year, traffic conditions, weather, and the like. As referred to herein, a charging station may include one or more chargers (e.g., charging ports). When multiple chargers are at a charging station, the chargers may be linked in serial on a same electrical circuit.

In one or more embodiments, when an EV arrives at a charging station, the charging station may verify the identity of the EV and/or driver to ensure that charging stations are not taken by unreserved EVs in place of reserved EVs. When an unreserved EV arrives at a charging station that has not been reserved, the unreserved EV may be allowed to connect to and receive power from the charging station. When an unreserved EV arrives at a charging station that has been reserved, the charging station may prevent power distribution to the unreserved EV to ensure that the charging station remains available for a reserved EV. Charging stations may use lighting or other indicators to communicate to a driver or EV that the charging station is available or reserved. The charging station availability may be indicated using the mobile application as well.

In one or more embodiments, the charging station dynamically may adjust the individual loads distributed to each connected EV based on the available overall load, the number of EVs, the charge needed for each EV, whether an EV has reserved the charging station, whether the EV has paid a premium for faster charging, and the like.

In one or more embodiments, the charging station may predict the amount of time needed to charge an EV. As a driver's vehicle is being charged, the mobile application may offer to the driver, via a predictive analysis on expected status of the charging, when the vehicle will be 80% and/or 100% charged, etc. The predicted charging status may be continuously updated based on conditions (e.g., other vehicles expected to arrive, new vehicles that have arrived, existing vehicles nearing full charge or expectation of any vehicles departing, and any other conditions that may speed up or slow down a charge). Additional analysis can be provided to depict historical data for a charger based on times of day or historical patterns of use for a location. For example, a charging station may provide users a percentage increase in charge per hour based on the time the EV has been connected or is expected to connect to the charging station. Some chargers in public areas may historically have higher demand than others, thereby making a decision to select between different chargers easier.

In one or more embodiments, to facilitate the EV charging station rental (e.g., in contrast with a pay-per-use PPU), a system may include a management system, a gateway, a mobile application, and on-board EV charging station hardware. The gateway may communicate with the management system, which may facilitate EV charging station rentals and charging boosts via the mobile application. For example, the gateway may use an OCPP (Open Charge Point Protocol) for communication with the management system. The gateway may instruct an EV charger what power to apply based on the power distribution determined by the management system for rented and PPU charging station uses. The EV charging station may manage the power distribution to one or more EVs based on the gateway's instructions, may lock and unlock the EV chargers, and may monitor power usage for metering purposes. The mobile application may communicate with the CSMS to present available EVs, estimated charging times, and prices, and to allow users to select EV charging stations to rent and boost, and to facilitate payments for EV charging stations. The gateway may provide a software-based load-management for the EV charging stations without requiring additional EV charging station hardware. For any user account, the management system may manage boost, cost, duration, rentals, property commissions, and mark-ups based on cost from an energy supplier, for example.

In one or more embodiments, the gateway may synchronize communication between the EV chargers and the management system (e.g., using OCPP as the communication protocol). In this manner, the management system may not communicate directly with the EV chargers. Instead, the gateway may receive traffic from the EV chargers and route the traffic to and from the management system. The gateway also may perform power management and load balancing (e.g., important for the boost function). The gateway may receive mobile application requests, via the management system, and perform the corresponding function for the relevant EV chargers, such as changing the load balanced across the charging bank and allowing one charger to charge at maximum output when using boost.

In one or more embodiments, the mobile application may communicate with the management system, but not the gateway. The mobile application may allow for opt-in commands, such as boost and EV charging station reservations (e.g., rentals and PPU). The mobile application may display charger availability and status in near real-time, and may use wireless communications such as near field communication to authenticate a user and unlock a charger.

In one or more embodiments, the management system may perform charger onboarding and registration (e.g., as part of a charger installation and maintenance). The management system may provide account onboarding (e.g., for rental premises, hospitality, commercial and public parking, and the like). The management system may manage boost cost and duration, and charging station reservation duration, at an account level. The management system may manage any commission payment to be made to a property or real estate investment trust (REIT). The management system may manage price markups on PPU usage. The management system may manage an EV charger type (e.g., rental or PPU) at an account level and/or charger level. The management system may allow multiple rental users to share rented EV spaces. The management system may manage EV reporting (e.g., to users, owners, government entities, etc. in accordance with relevant privacy laws). The management system may manage billing statements for EV users even though the billing may occur outside of the management system. The management system may manage service tickets to report faults and needed maintenance at the EV charging stations.

In one or more embodiments, the EV charger may include a retraction mechanism and retraction activation. The retraction mechanism may include a mechanical means, such as a leaf or coiled spring (e.g., 360 degree locking tooth spindle, only locking on outbound, at any position), a cam-action, piston, hand crank, or foot pump. The retraction mechanism may be motorized and may be adapted for use with heavy gauge cable. The retraction may include a mechanism to sense tension/resistance and stop retraction—for example: stop retraction if the cable is kinked, the cable is twisted or caught under a tire, or wrapped around the stand or someone's foot. Retraction may be activated by pushing a button on the handle with a switch (e.g., only retracts as long as the button is pressed). Retraction may be activated by docking the handle. Retraction may be activated by logic-based on sensor data and/or a timing mechanism—if someone drops the handle and drives away—the charger senses that the handle is not hooked up to a vehicle and retracts on its own after a set period of time/vehicle leaves/user pays. The retraction may occur automatically after a predetermined period, once docked. As the cable is pulled out, there may be minimal resistance in the internal spring. When the cable is plugged back into the charging station, an internal motor may wind the cable up.

In one or more embodiments, the mounting system for the EV charging station may be a dual-mounted pedestal with a swing-away wall mount. A spring or motor may provide a load force and may pull in a cable of the charger. To make the cable easier to pull out of the reel, the charging station may be mounted on a hinge with an internal spring that would allow the charging station to pivot away from the wall to which it may be mounted. When the cable is returned (e.g., reeled in), the internal spring may cause the charging station to hinge back to its original position. To make it easier to pull the cable out of the reel, the charging station may be mounted 90 degrees to the wall (e.g., rather than parallel to the wall).

In one or more embodiments, the EV charging station may include lighting or other indication of the charger status (e.g., available/unavailable, reserved/unreserved, estimated charging time remaining, etc.).

The above descriptions are for purposes of illustration and are not meant to be limiting. Numerous other examples, configurations, processes, etc., may exist, some of which are described in greater detail below. Example embodiments will now be described with reference to the accompanying figures.

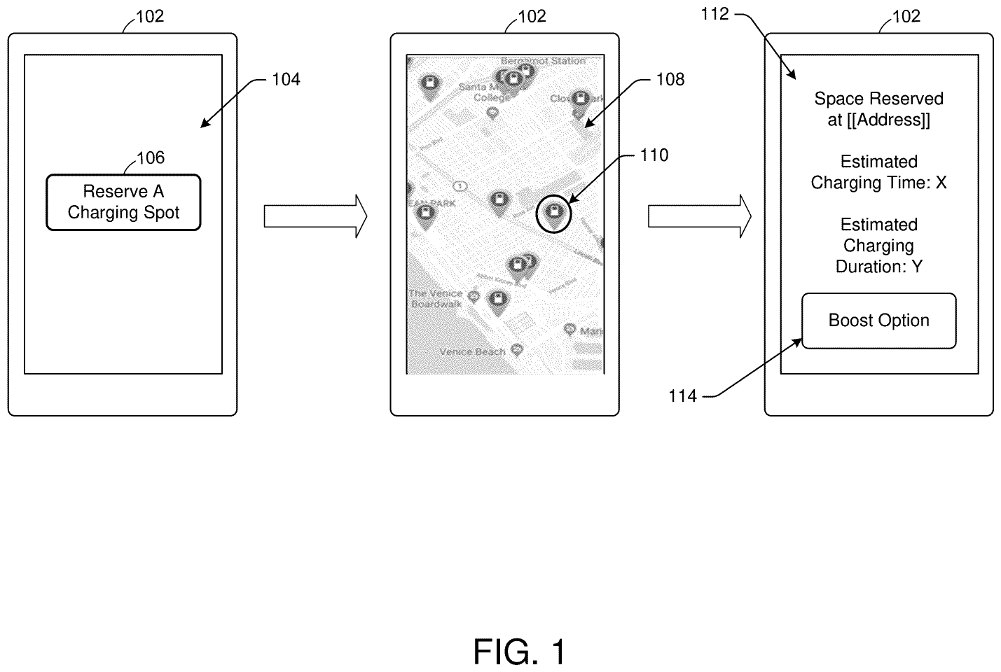

FIG. 1 illustrates example mobile application interfaces for reserving electric vehicle (EV) charging stations in accordance with one embodiment.

Referring to FIG. 1, a user device 102 (e.g., a smartphone, tablet, wearable device, or the like) may run an application for identifying and reserving EV charging stations. A user may be able to request, via the mobile application (e.g., interface 104 with selectable reservation option 106), reservation of an EV charging station, and the mobile application may present one or more nearby options for EV charging stations (e.g., interface 108 with EV charging station 110). The mobile application may indicate which EV charging stations may be available at the current time or at a later time (e.g., based on an estimated arrival time of the EV based on the locations of the EV and the EV charging station). Once a user selects an EV charging station to reserve, the mobile application may confirm (e.g., using interface 112) the reservation so that the EV driver is made aware of the location and duration of the reservation, and may allow the user to select a boost option 114 to receive more power than one or more other EVs at the same charging bank (e.g., to charge faster than other EVs).

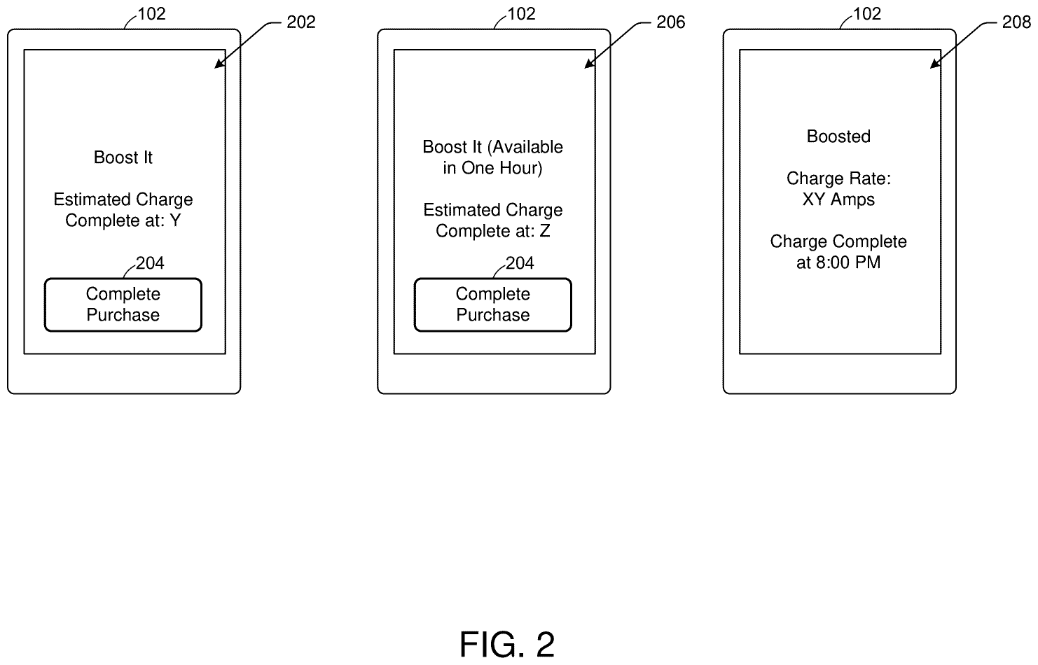

FIG. 2 illustrates example mobile application interfaces for purchasing EV charging in accordance with one embodiment.

Referring to FIG. 2, the user device 102 of FIG. 1 may allow a user to purchase the EV charge (e.g., using interface 202 with purchase option 204 to rent an EV charging station at an EV charging bank), which may vary in price based on the amount of charge needed, the time of day, the location, the current and/or expected charging demand at the charging station, and the like. The mobile application may allow a user to “boost” their EV charge so that the EV is charged faster. The boost option may be available (e.g., using interface 206) at the current time or a future time, as indicated via the mobile application. The mobile application may estimate the time needed to charge the EV and may indicate the estimate, and may indicate after the charge whether a boost was used, the amperage used, and the time of charge completion. There may be a waiting line for use of the boost feature, and a driver may wait in the line for a next available boost slot at any charging station. The wait time for an available boost slot may be estimated by the mobile application and/or charging station based on the current use of other EVs, the grid load, and the available power. Boost slots may be for set time periods, such as one hour slots. When the charge has completed, the charge rate and time at which the charge completed may be presented (e.g., using interface 208), along with a confirmation of a selected boost and/or the cost of the EV charge.

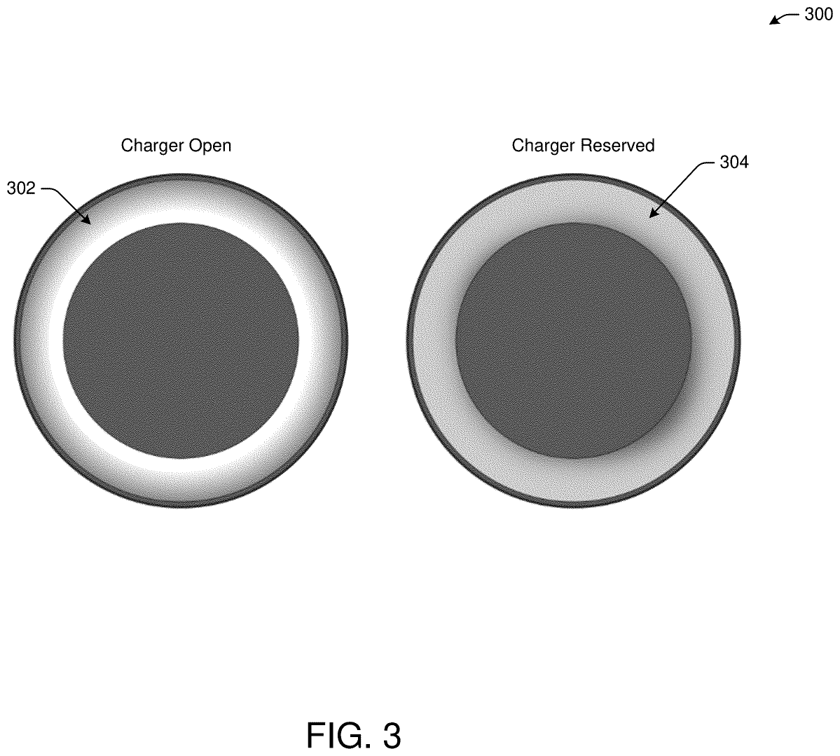

FIG. 3 illustrates example EV charging displays 300 in accordance with one embodiment.

Referring to FIG. 3, an EV charging station may use lights or other indicators to communicate to drivers whether a charging station is available or is reserved (e.g., an status indicator 302 for when the charger is available/open, and a status indicator 304 for when the charger is reserved). A reserved indicator may communicate that even though the charging station may not be used at the current time, it is reserved for future use and therefore cannot be used by someone other than the reserved driver. In particular, as explained further herein, when an unreserved driver attempts to use a reserved charging station, the charging station may prevent the connection and/or may prevent a power distribution to the EV, so as to maintain the reservation for the reserved EV. The status indicators for available/open and reserved may be lights of different colors, lights on or off, lights of varying brightness, or the like.

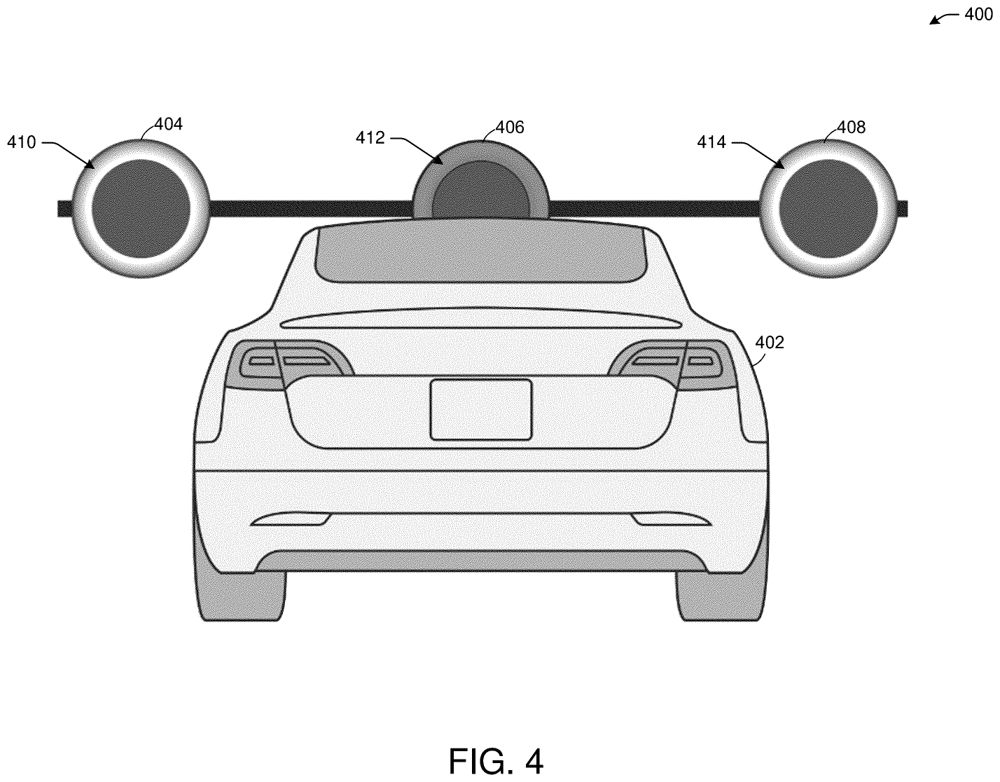

FIG. 4 illustrates example EV charging bank 400 in accordance with one embodiment.

As shown in FIG. 4, when an EV 402 is using the EV charging bank 400 that includes charging station 404 with indicator 410, charging station 406 with indicator 412, and charging station 408 with indicator 414 (e.g., the EV 402 is shown as using the charging station 406), the indicator 412 may communicate that the charging station 406 is in use. In contrast, the indicators 410 and 414 of the unused EV charging stations may indicate whether they are available or reserved for future use.

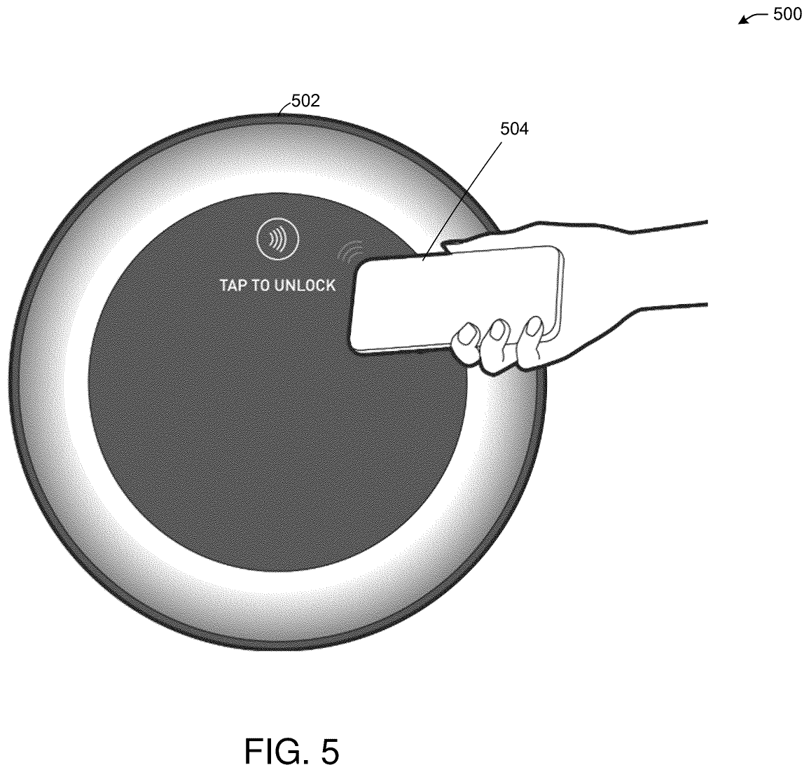

FIG. 5 illustrates an example system 500 for verifying a user of an EV charging station in accordance with one embodiment.

Referring to FIG. 5, the EV charging station 502 may need to verify a user/EV for payment and reservation purposes. In particular, the EV charging station 502 may need to verify that an EV attempting to connect to the EV charging station 502 is the EV that reserved the EV charging station 502 and to verify that the user or vehicle is one of one or more users or vehicles allowed to use the reservation. Even when the charging station is unreserved, the EV charging station 502 may validate a user/EV to identify a corresponding user account to which a payment method may be linked for deducting the price of the use of the charging station. The verification may occur via device 504, as shown, such as by having a user device tap the EV charging station 502 and provide a QR code or other short-wave transmission to securely identify the driver/EV. Alternatively, the EV charging station 502 may allow a user to enter or swipe a payment method, to input an account or EV identifier, or may automatically identify an EV (e.g., using a camera and image recognition of a license plate or VIN number, and/or by having the vehicle provide an identifier via transmission to the charging station when connected to the charging station).

In one or more embodiments, when the EV charging station 502 is part of a hotel property, the EV charging station 502 may be unlocked by a room key instead of the mobile application, whether the room key is digital on the device 504 or is a separate fob or tag, for example.

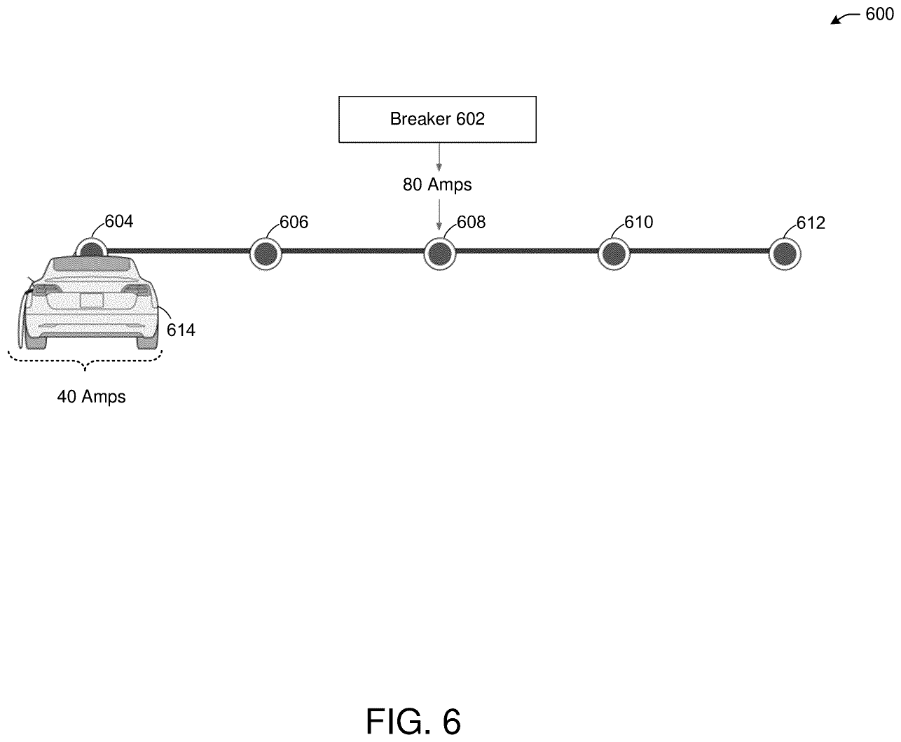

FIG. 6 illustrates example EV charging bank 600 power distribution in accordance with one embodiment.

As shown in FIG. 6, the EV charging bank 600 may include a breaker 602 to distribute electricity (e.g., 80 amps as shown, or another amount) to multiple charging stations 604, 606, 608, 610, and 612. An EV 614 may have a maximum amount of amperage that it may receive from an EV charging station (e.g., 40 amps). When the EV 614 is the only EV using the EV charging bank 600, the EV charging bank 600 may distribute the maximum amperage to the EV 614 as shown in FIG. 6.

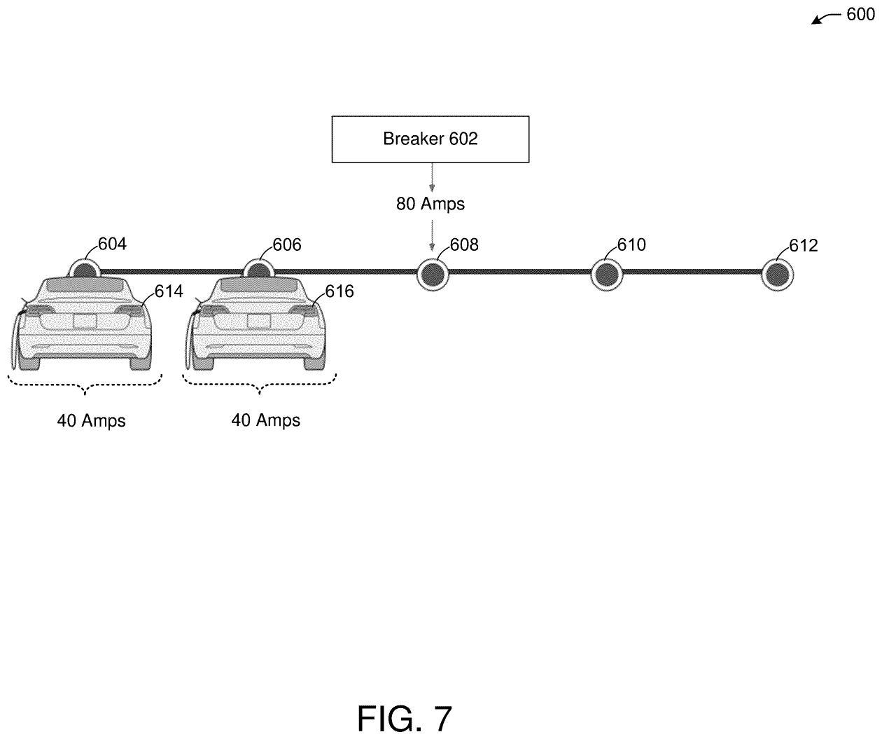

FIG. 7 illustrates the EV charging bank 600 of FIG. 6 distributing power to multiple EVs in accordance with one embodiment.

As shown in FIG. 7, when two EVs (e.g., the EV 614 and an EV 616) concurrently use the EV charging bank 600 (e.g., the charging station 604 and the charging station 606), they may need to split the available power provided by the EV charging bank 600. Because the two EVs each may receive up to 40 amps (e.g., 80 amps between the two EVs), which may or may not exceed the maximum current provided by the EV charging bank 600, the current provided by the EV charging bank 600 may need to be divided among the two EVs (e.g., in the example shown, the amperage distribution is equal, but unequal distribution may be allowed in other situations described herein).

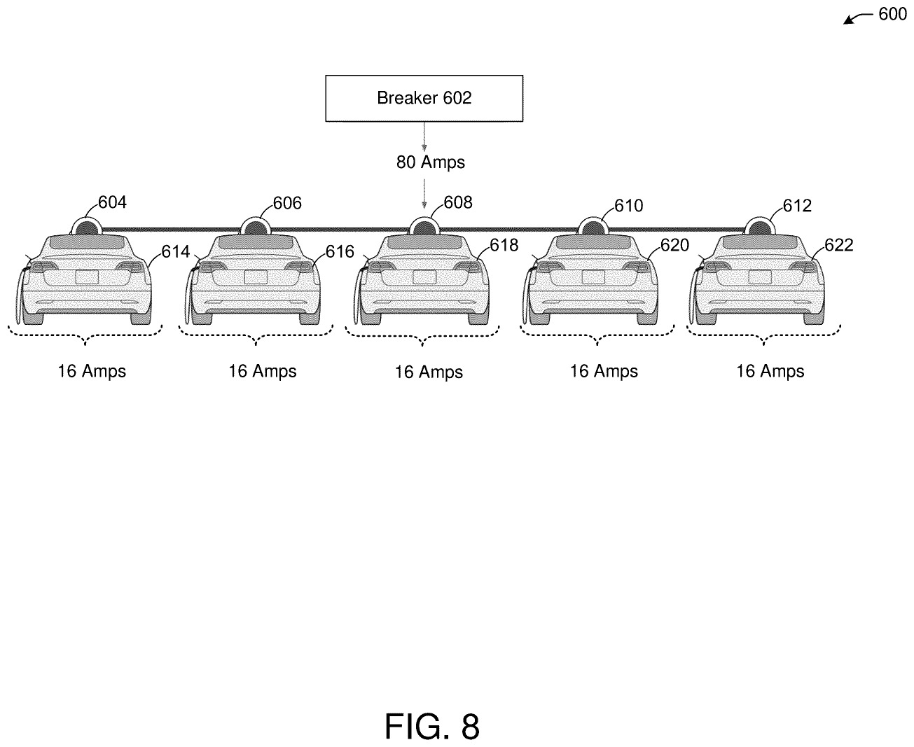

FIG. 8 illustrates the EV charging bank 600 of FIG. 6 distributing power to multiple EVs in accordance with one embodiment.

As shown in FIG. 8, as more vehicles concurrently use a charging station (e.g., EVs 618, 620, and 622 join the EVs 614 and 616 at the EV charging bank 600), the amount of current that may be distributed to each vehicle may drop to share amperage among the vehicles. In the example shown, the EV charging bank 600 may provide 80 amps, which may be distributed equally among five EVs (e.g., 16 amps per EV as shown). When one EV leaves, the current that it was using may be redistributed among the other EVs.

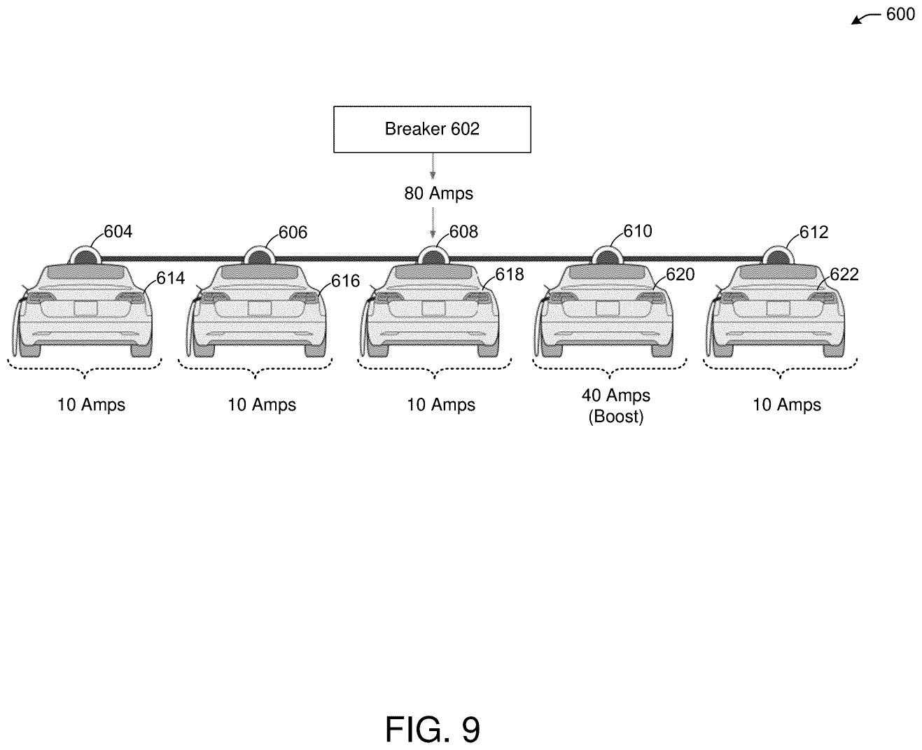

FIG. 9 illustrates the EV charging bank 600 of FIG. 6 distributing power to multiple EVs in accordance with one embodiment.

As shown in FIG. 9, the distribution of current across multiple EVs at a charging station may not be equal among each EV. For example, when a user has a premium charge (e.g., a boost, is a premium subscriber, is an emergency or law enforcement vehicle, etc.), the user's EV (e.g., the EV 620) may be distributed more amperage than one or more of the other EVs (e.g., the maximum 40 amps versus 10 amps for the other EVs) so that the EV 620 may charge faster. In this manner, the amount of amperage used to charge any EV may change dynamically as EVs connect to and disconnect from the charging station.

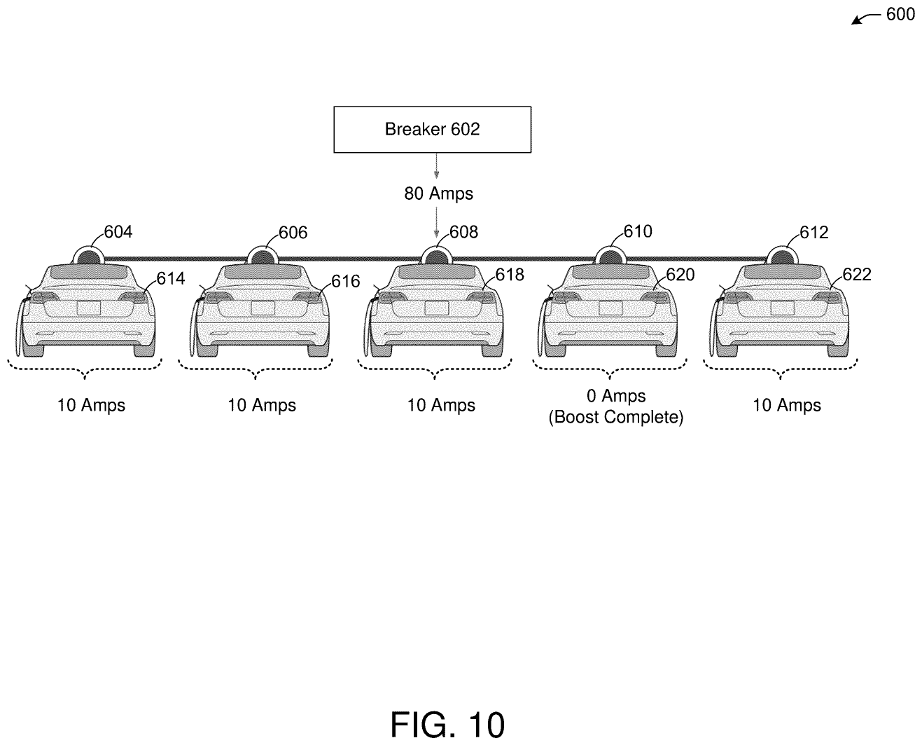

FIG. 10 illustrates the EV charging bank 600 of FIG. 6 distributing power to multiple EVs in accordance with one embodiment.

FIG. 10 shows the redistribution of amperage from an EV that has finished charging (e.g., the EV 620) to EVs still connected to the EV charging bank 600. As compared with FIG. 9, the still-charging EVs may go from 10 to 20 amps once one EV completes its charge.

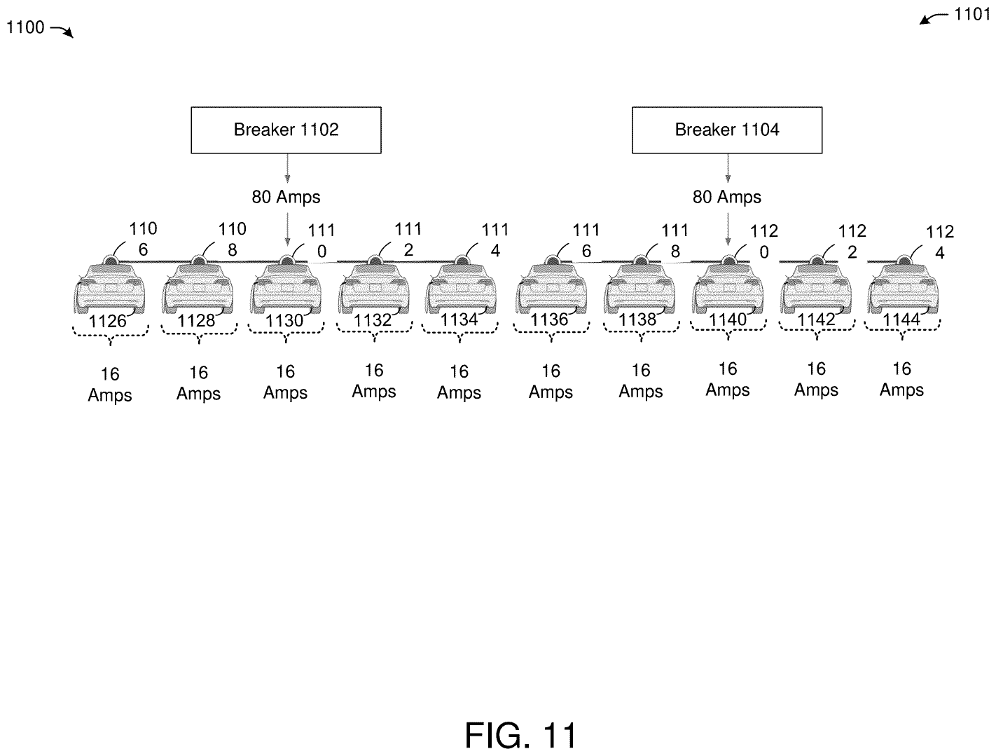

FIG. 11 illustrates example EV charging bank power distribution in accordance with one embodiment.

Referring to FIG. 11, multiple charging banks (e.g., EV charging bank 1100, EV charging bank 1101) distribution systems may be employed, each having multiple charging stations (e.g., the EV charging bank 1100 may have the EV charging stations 1106, 1108, 1110, 1112, and 1114, and the EV charging bank 1101 may have the EV charging stations 1116, 1118, 1120, 1122, and 1124). As shown, two EV charging banks each may connect to five EVs to distribute 80 amps per system (e.g., the EV charging bank 1100 may distribute power to EVs 1126, 1128, 1130, 1132, and 1134, and the EV charging bank 1101 may distribute power to the EVs 1136, 1138, 1140, 1142, and 1144). The number of stations that may be available at charging station distribution systems, and the number of charging station distribution systems at a location, may vary.

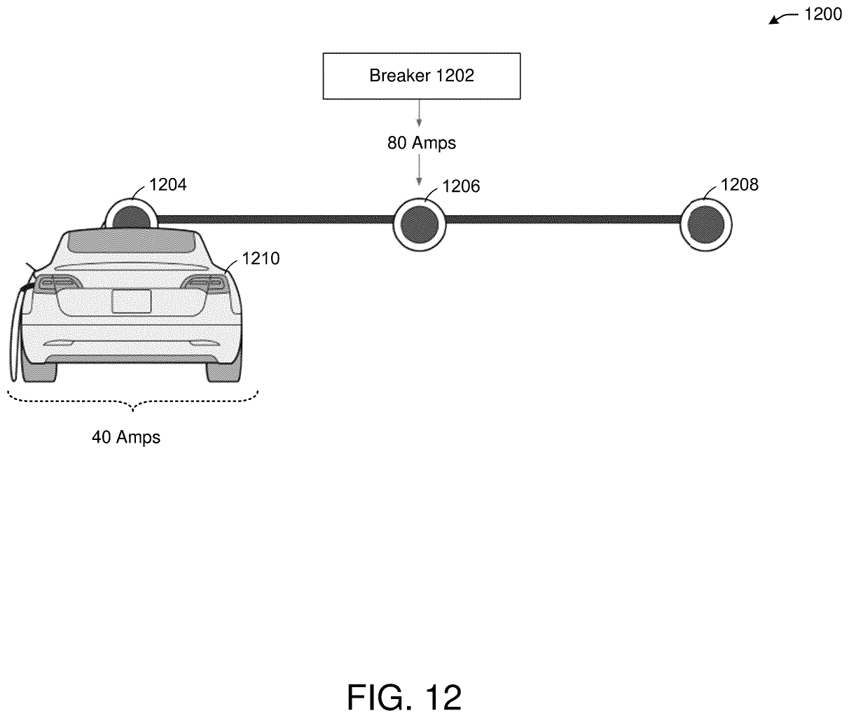

FIG. 12 illustrates an example EV charging bank 1200 power distribution in accordance with one embodiment.

As shown in FIG. 12, the EV charging bank 1200 includes charging station 1204, charging station 1206, and charging station 1208, and may distribute electricity (e.g., 80 amps or another amount) to the charging stations. In FIG. 12, a single EV 1210 is shown using the charging station 1204. A single EV should be able to receive the maximum current (e.g., 40 amps) from a charging station when it is the only connected EV at a time.

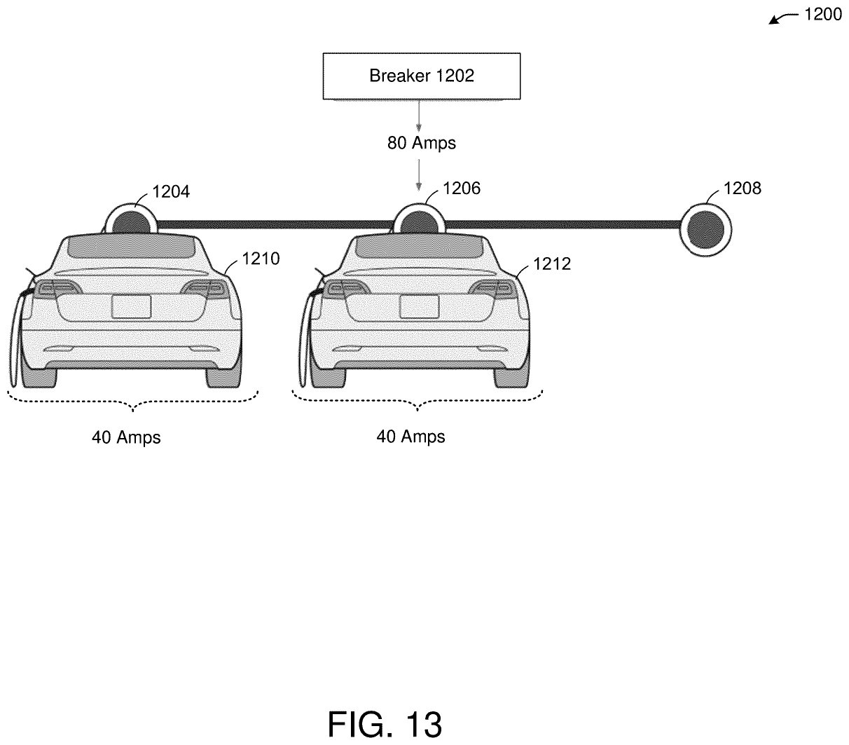

FIG. 13 illustrates the example EV charging bank 1200 of FIG. 12 distributing power to multiple EVs in accordance with one embodiment.

Referring to FIG. 13, when a second EV 1200 connects to the charging station 1206 of FIG. 12, the charging station 1206 may or may not have to drop the amperage distributed to the first EV 1210 to split the amperage between the two EVs.

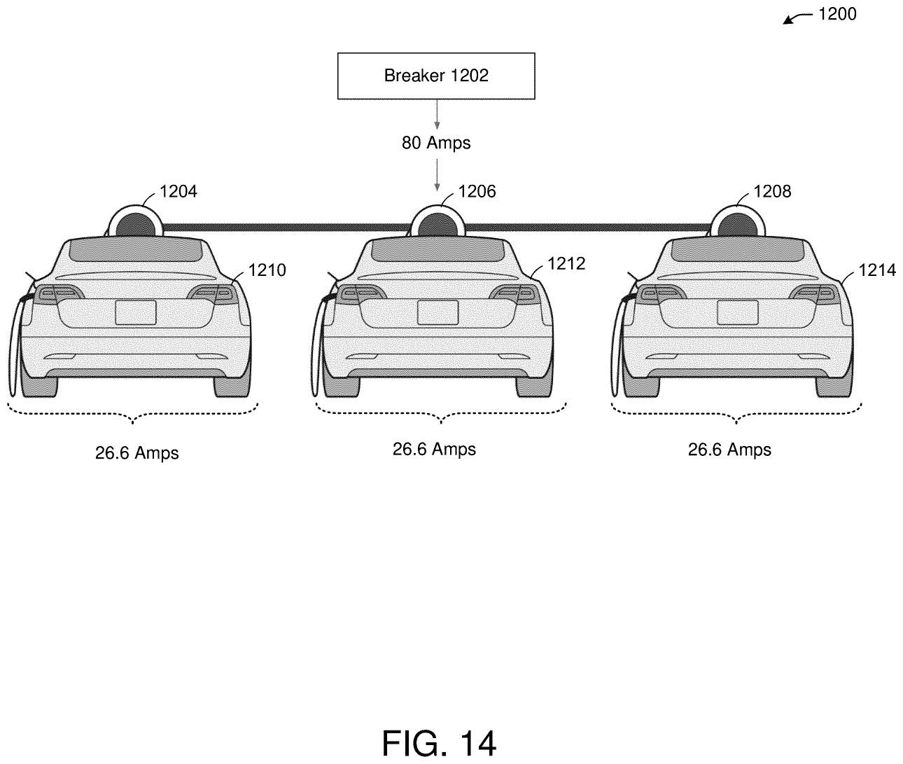

FIG. 14 illustrates the example EV charging bank 1200 of FIG. 12 distributing power to multiple EVs in accordance with one embodiment.

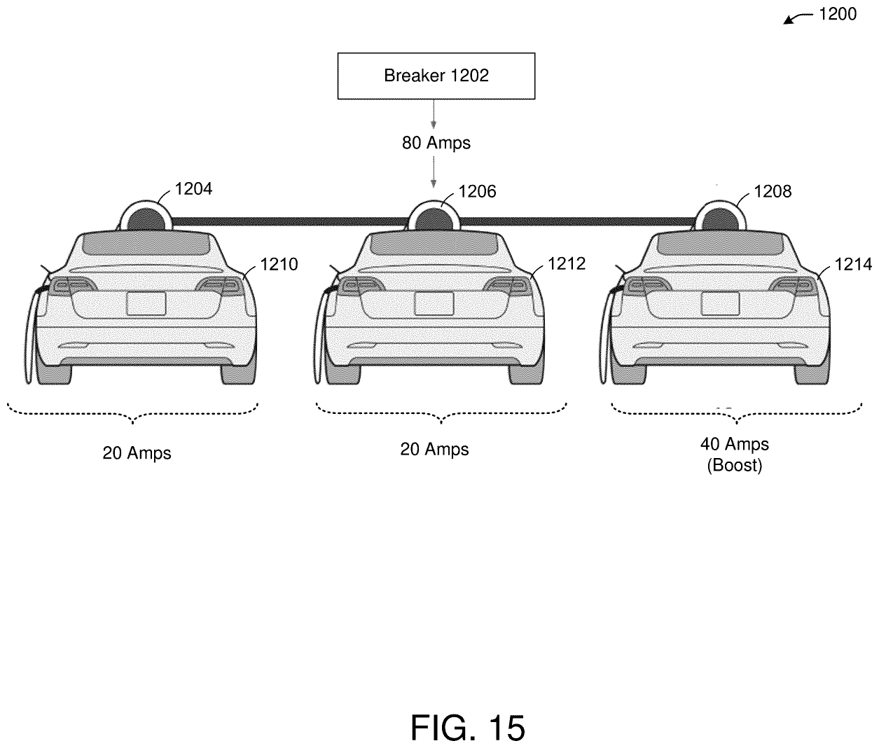

Referring to FIG. 14, when a third EV 1214 connects to the charging station 1208 of FIG. 12, the charging station 1208 may have to drop the amperage distributed to the first and second EVs (e.g., from 40 amps to 26.6 amps) to split the amperage between the three EVs. In FIG. 14, the amperage may be split evenly among the three EVs, but it is possible that the EV charging bank 1214 may distribute more amperage to one EV than to another as shown in FIG. 15.

FIG. 15 illustrates the example EV charging bank 1200 of FIG. 12 distributing power to multiple EVs in accordance with one embodiment.

Compared with FIG. 14, FIG. 15 includes the third EV 1214 using a premium quick charge (e.g., boost) that draws more amps from the charging station (e.g., 40 amps), so the non-premium charges of the first and second EVs may receive further reduced amperages (e.g., 20 amps).

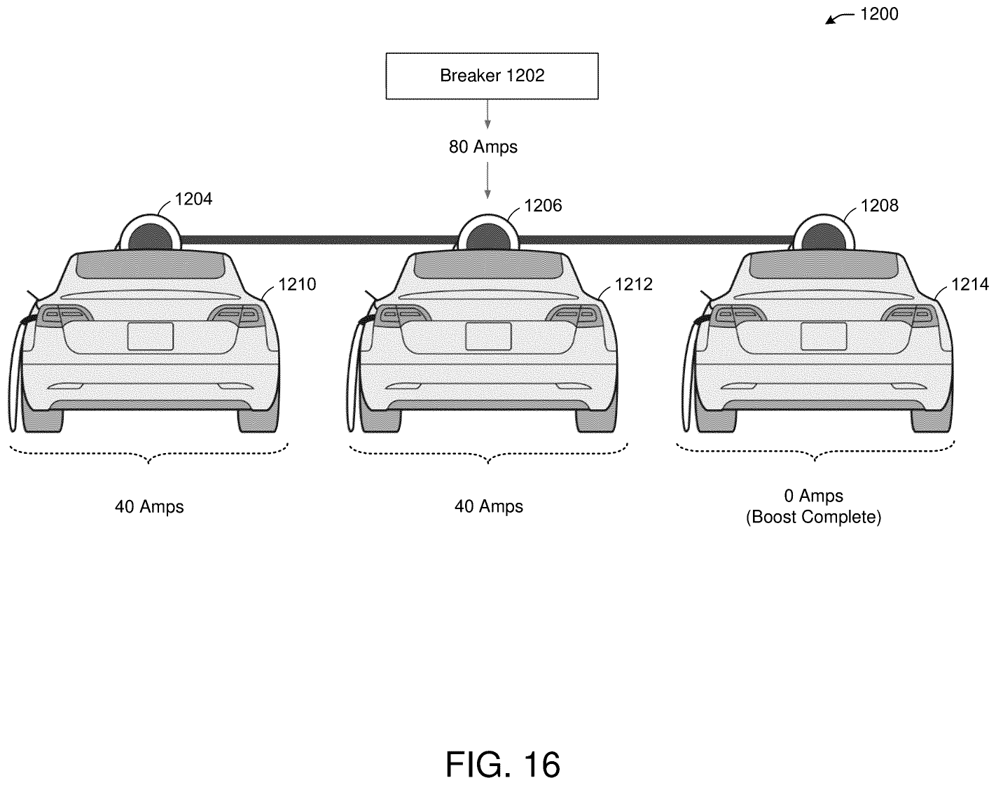

FIG. 16 illustrates the example EV charging bank 1200 of FIG. 12 distributing power to multiple EVs in accordance with one embodiment.

When the third EV 1214 finishes its charge, the EV charging bank 1200 may redistribute the amps previously used by the third EV 1214 to the first and second EVs 1210 and 1212, increasing the charge provided to the first and second EVs 1210 and 1212 (e.g., from 20 amps to 40 amps each).

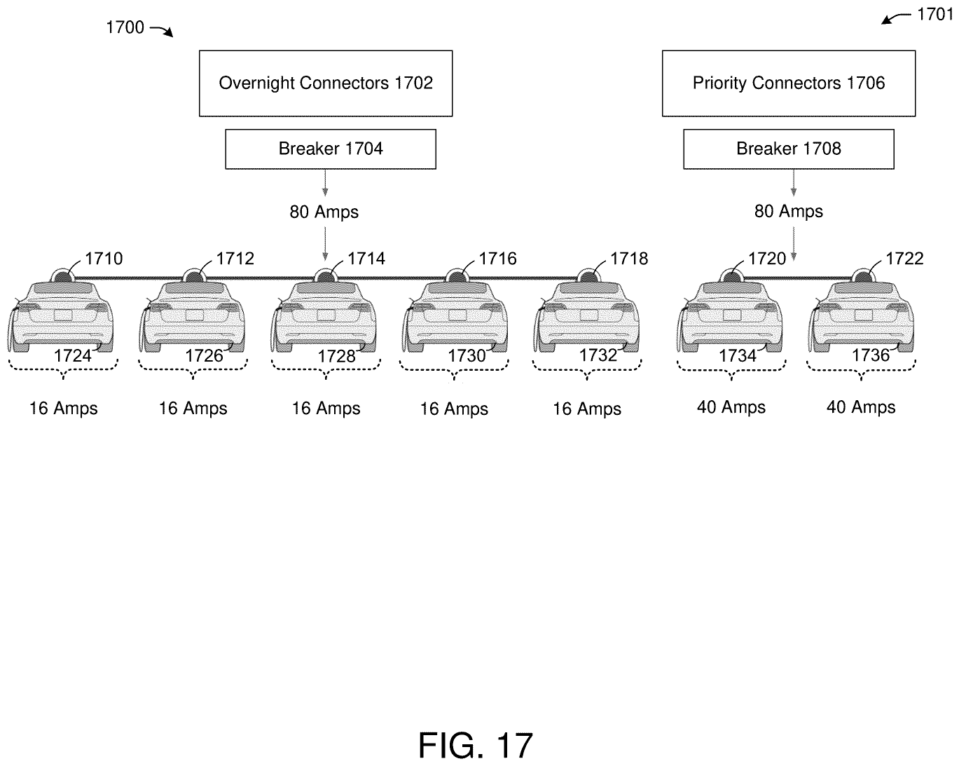

FIG. 17 illustrates an example EV charging bank power distribution in accordance with one embodiment.

In FIG. 17, it is shown that an EV charging bank 1700 and an EV charging bank 1701 may have different numbers of charging stations of different types. For example, the EV charging bank 1700 may include overnight connectors 1702 with breaker 1704 for charging stations 1710, 1712, 1714, 1716, and 1718. The EV charging bank 1701 may include priority (e.g., boost) connectors 1706 with breaker 1708 for charging stations 1720 and 1722. EVs 1724, 1726, 1728, 1730, and 1732 may concurrently use the overnight connectors 1702, and EVs 1734 and 1736 may concurrently use the priority connectors 1706. In the example shown, the overnight connectors 1702 and the priority connectors 1706 may distribute the same load (e.g., 80 amps), but because the overnight connectors 1702 may accommodate five EVs and the priority connectors 1706 may accommodate two EVs, the minimum load that may be provided to an EV using the priority connectors 1702 may be less than the minimum load that may be provided to an EV using the priority connectors 1706.

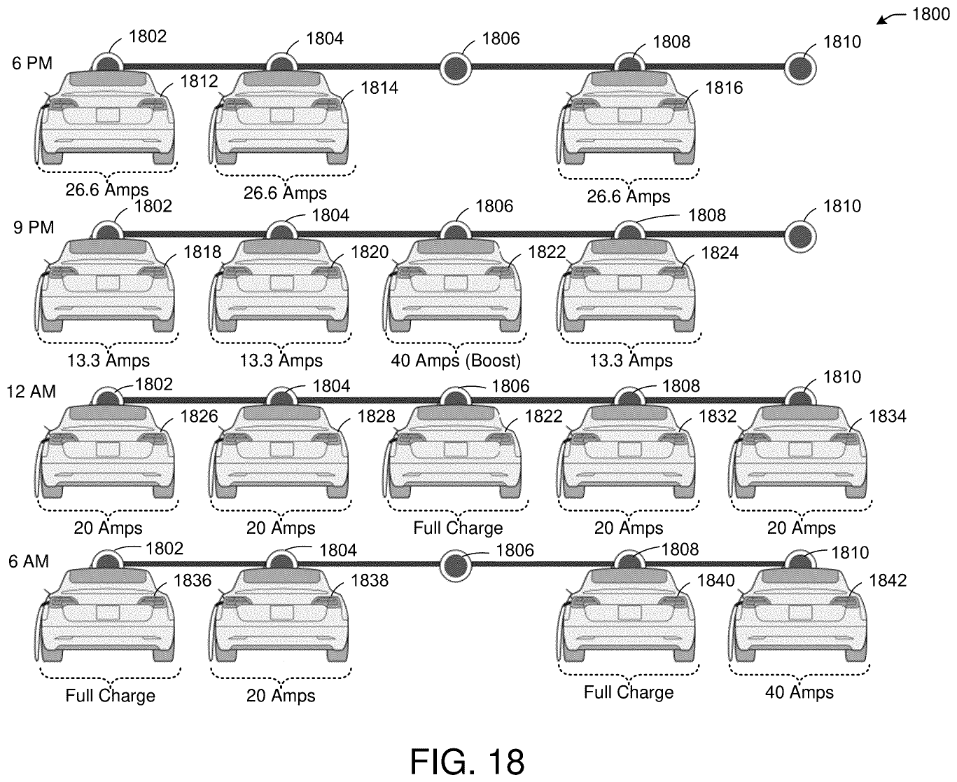

FIG. 18 illustrates example EV charging bank 1800 power distribution in accordance with one embodiment.

Referring to FIG. 18, the amperage distributed to each vehicle at the EV charging bank 1800 (e.g., to each charging station at the EV charging bank 1800) may vary at different times based on the number of EVs using the charging station and how much amperage each EV uses. The EV charging bank 1800 may include charging stations 1802, 1804, 1806, 1808, and 1810. For example, at 6 PM, 80 amps may be distributed among three EVs (e.g. EV 1812 using the charging station 1802, EV 1814 using the charging station 1804, and EV 1816 using the charging station 1808) at 26.6 amps per EV. At 9 PM, four EVs may use charging stations (e.g., EV 1818 may use the charging station 1802, EV 1820 may use the charging station 1804, EV 1822 may use the charging station 1808. The EV 1822 may represent a premium quick charge (e.g., boost) EV that may use 40 amps, leaving 13.3 amps for three other connected EVs.

Still referring to FIG. 18, at midnight, five EVs (EV 1826, EV 1828, EV 1822, EV 1832, and EV 1834) may use the charging stations. The EV 1822 may complete its charge, leaving 20 amps to charge each of four other EVs (e.g., when the EV 1822 completes its charge, the EV charging bank 1800 may redistribute power to the EVs still connected and charging). At 6 AM, two of four EVs (e.g., EV 1836, EV 1838, EV 1840, and EV 1842) may complete their charges (e.g., EV 1836 and EV 1840 may complete their charges), leaving 40 amps for each of two remaining EVs so that EV 1838 and EV 1842 may receive more power than they had been receiving prior to the two EVs completing their charges.

In one or more embodiments, the charging station and/or mobile application may have access to data indicative of charging demand at any charging station at different times. Based on the time of day, day of week, traffic conditions, EVs known to be in a given area (e.g., based on user consent and/or data collected in accordance with relevant laws), the charging station and/or mobile application may estimate availability and charging durations, and may use the estimates to allow users to reserve charging stations, to direct drivers to charging stations, to offer incentives to use or not use charging stations, to vary prices of charging an EV, and the like.

Referring to FIGS. 6-18, the available amperage shown at the EV charging banks is 80 amps. This amperage is not meant to be limiting, and other amperages may be used. Accordingly, the load shifting may adjust based on the amperage used. For example, if 70 amps were used instead of 80 amps as shown in FIGS. 6-18, when to EVs concurrently use EV charging banks as shown in FIG. 7, they may split the amperage at 35 amps per EV. Likewise, using 70 amps in FIG. 8 with five EVs may result in each EV receiving 14 amps instead of 16 amps. Also referring to FIGS. 6-18, the EV charging banks are shown as serially linking multiple charging ports, any of which may be reserved and used individually, with electrical ports linked at a charging station sharing the electrical load at the charging station.

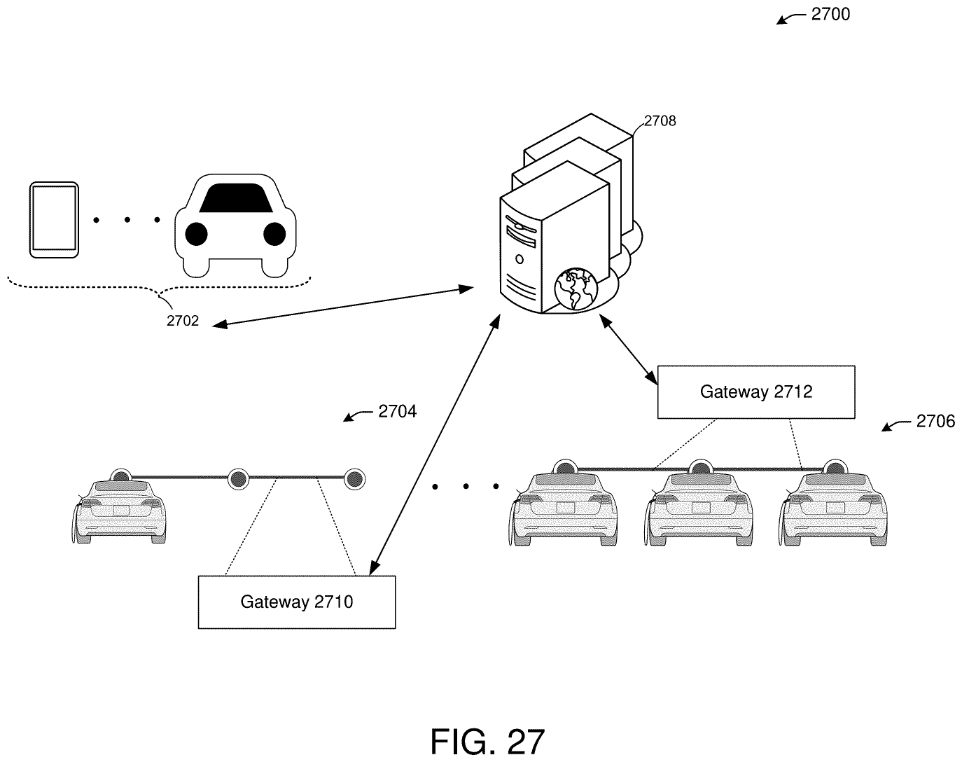

In one or more embodiments, the manner in which the EV charging stations of the EV charging banks of FIGS. 6-18 may be reserved and the manner in which power may be distributed to the EV charging stations based on the number of EVs using the charging banks and whether the EVs use the boost function is described more below with respect to FIG. 27.

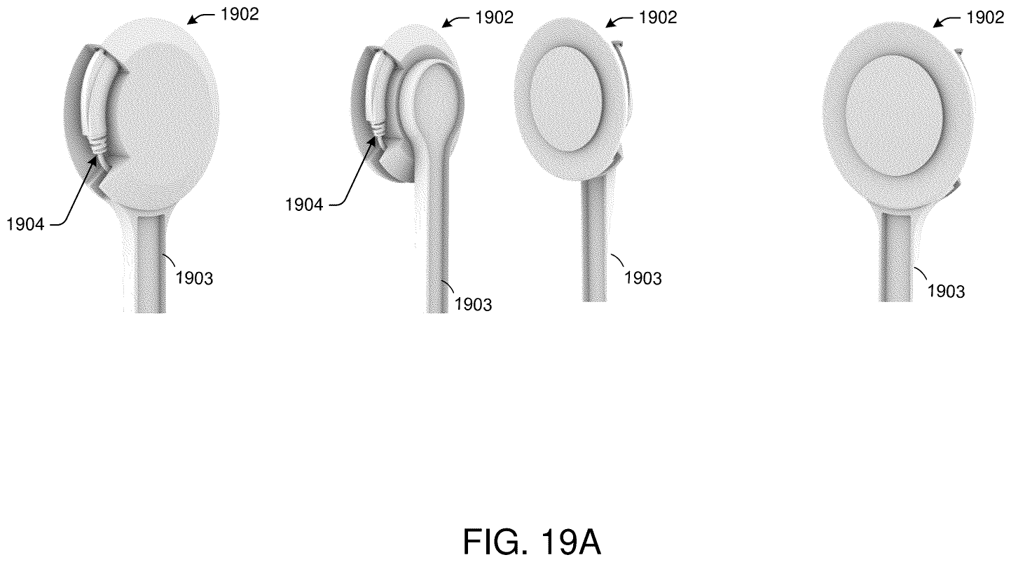

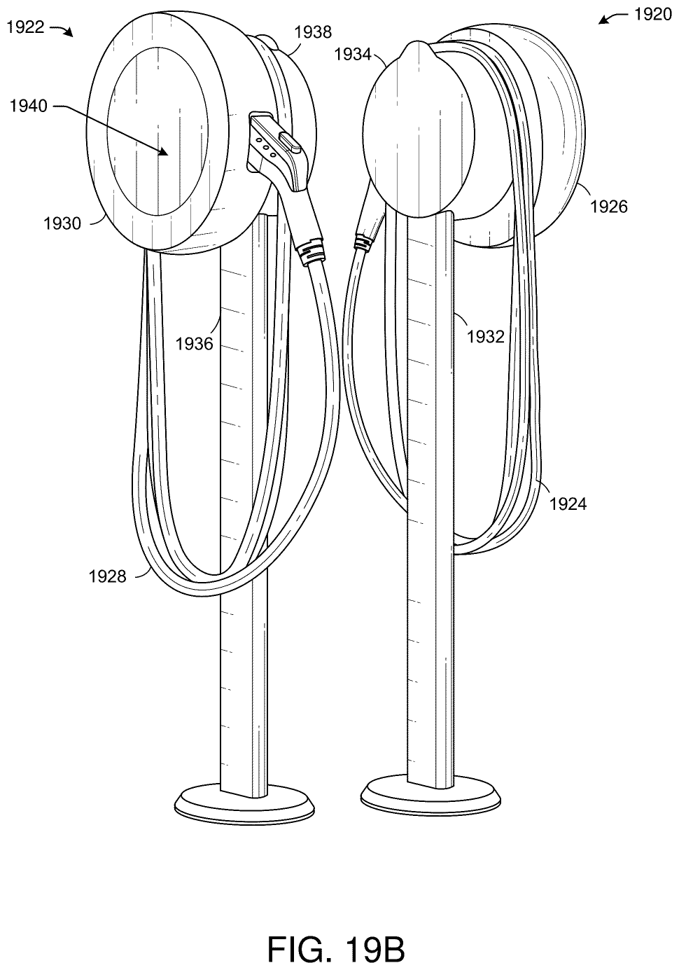

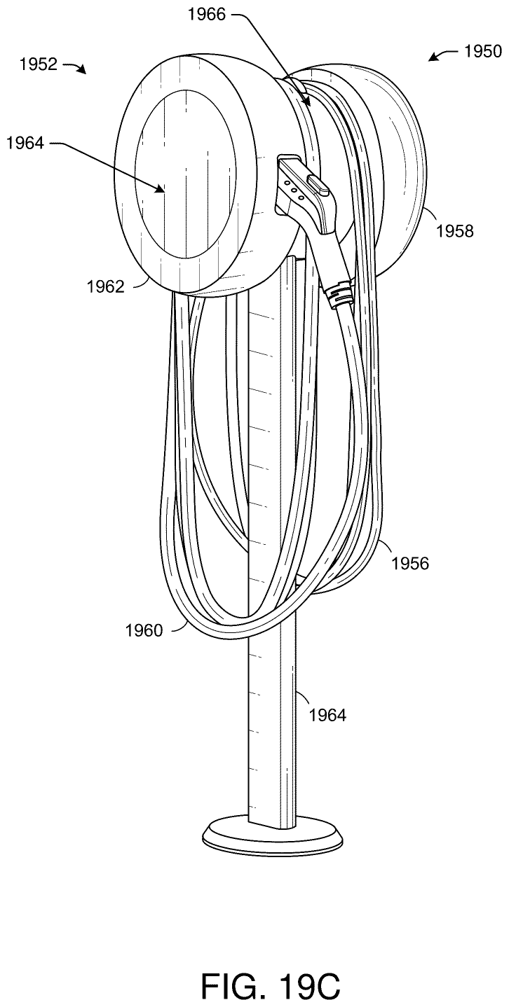

FIG. 19A illustrates an example EV charger 1902 in accordance with one embodiment.

Referring to FIG. 19A, the EV charger 1902 may include a pedestal 1903 with a “Y-shape” or “lollipop shape,” and may include a handle. A cable 1904 may run from one side of the EV charger 1902, affecting the usability. The pedestal 1903 may be attached from the back, which may improve the usability as the cable 1904 may run from the bottom of the circle. The cable 1904 running symmetrically from the bottom may ease the pulling in different directions.

FIG. 19B illustrates example EV chargers with separate casting in accordance with one embodiment.

Referring to FIG. 19B, EV charger 1920 and EV charger 1920 are shown. The EV charger 1920 may include a charging cable 1924 that may wrap around a housing 1926, and the EV charger 1922 may include a charging cable 1928 that may wrap around a housing 1930 (e.g., the charging cable 1924 and the charging cable 1928 may not be retractable). The housing 1926 may be mounted or otherwise connected to a post 1932 via a casting 1934, and the housing 1930 may be mounted or otherwise connected to a post 1936 via a casting 1938. A light 1940 is shown for the EV charger 1922, and may display charging status, an indication of an organization for which the EV charger 1922 is to be used, or the like.

FIG. 19B illustrates example EV chargers with shared casting in accordance with one embodiment.

Referring to FIG. 19C, EV charger 1950 and EV charger 1952 are shown. The EV charger 1950 and the EV charger 1952 may be connected to a post 1954. The EV charger 1950 may include a charging cable 1956 that may wrap around a housing 1958, and the EV charger 1952 may include a charging cable 1960 that may wrap around a housing 1962 (e.g., the charging cable 1956 and the charging cable 1960 may not be retractable). The housing 1958 and the housing 1962 may be mounted or otherwise connected to a post 1964 via a casting 1966. A light 1964 is shown for the EV charger 1952, and may display charging status, an indication of an organization for which the EV charger 1952 is to be used, or the like.

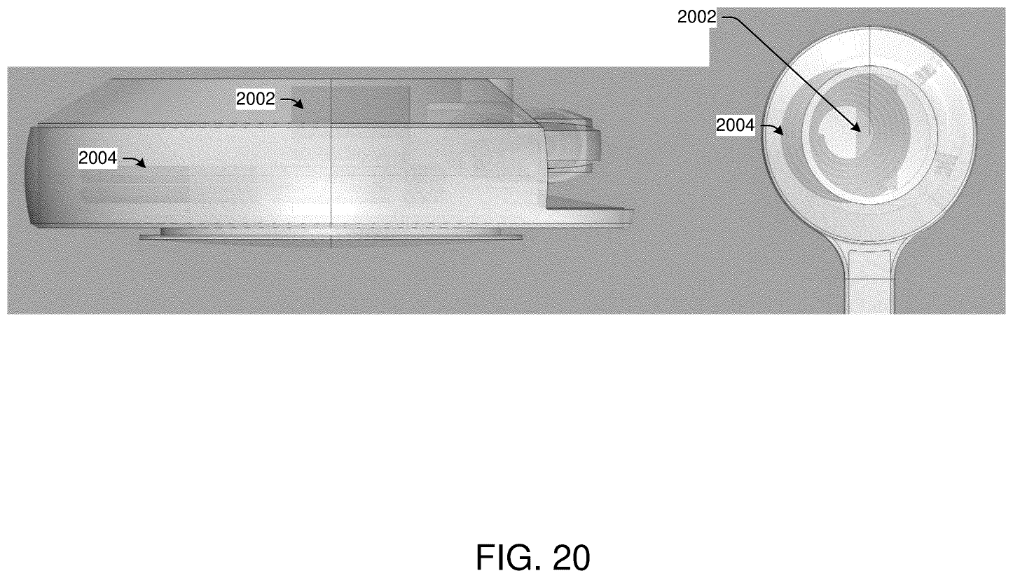

FIG. 20 illustrates an example EV charger 2002 in accordance with one embodiment.

FIG. 20 shows the EV charger 2002 and the reeled in cable 2004 that transmits power from the EV charger 2002 to an EV battery of a connected EV.

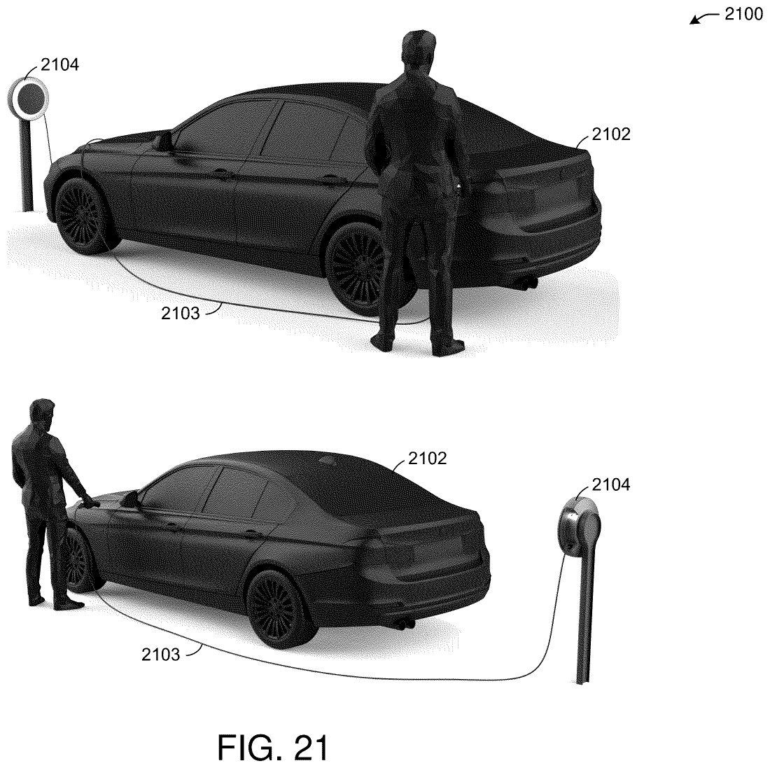

FIG. 21 illustrates example EV charger environments 2100 in accordance with one embodiment.

In FIG. 21, it is shown that an EV 2102 may connect to the cable 2103 of an EV charger 2104 from the front or rear end of the EV 2102. In this manner, the cable 2103 should be long enough to pull out from the charging station reel to make the EV connection.

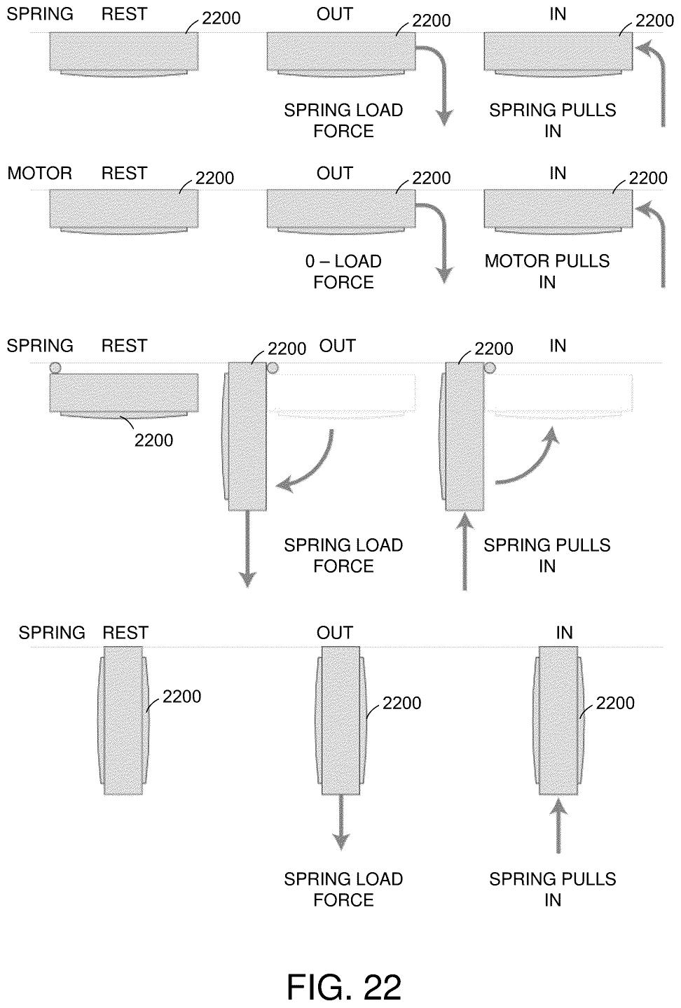

FIG. 22 illustrates example EV charger mounting systems in accordance with one embodiment.

Referring to FIG. 22, the EV charging mounting system 2200 may include a spring or motor, which may provide a load force as the cable is reeled out, and may pull in the cable for retraction. A spring load force may lock out the EV charger, and may pull the EV charger back in.

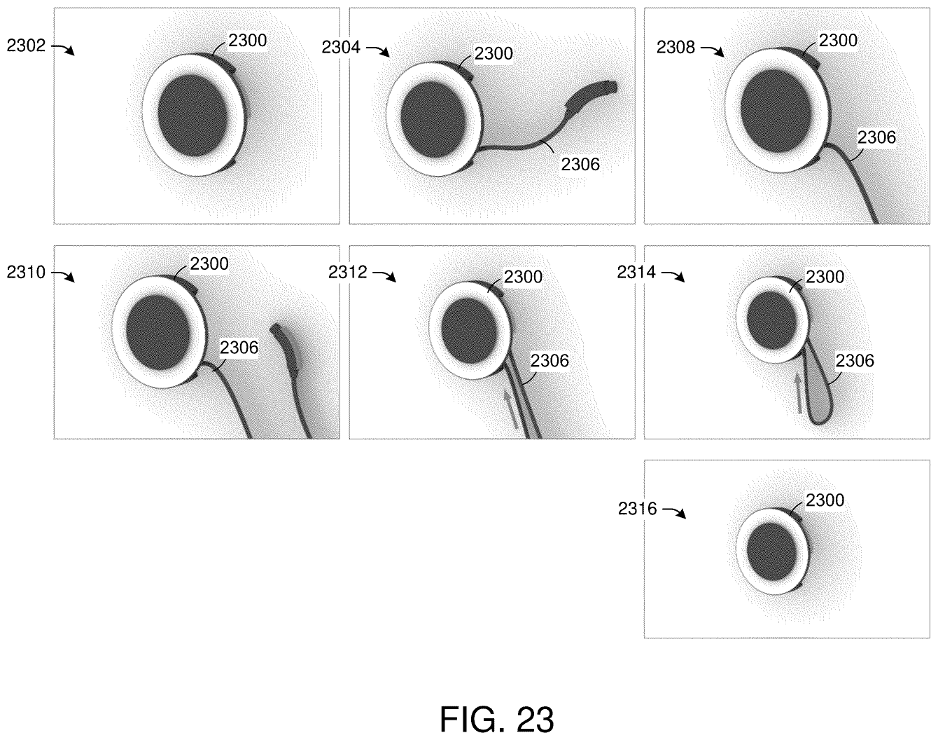

FIG. 23 illustrates an example EV charger retraction in accordance with one embodiment.

Referring to FIG. 23, an EV charger 2300 is shown in multiple positions. At position 2302, the EV charger 2300 is in a retracted position. At position 2304, a cable 2306 of the EV charger 2300 is shown as partially removed from the EV charger 2300. At position 2308, the cable 2306 is more extended, and at position 2310, the cable 2306 is even more extended. At position 2312, the cable 2306 is retracting. At position 2314, the cable 2306 is even further retracted. At position 2316, the cable 2306 is fully retracted.

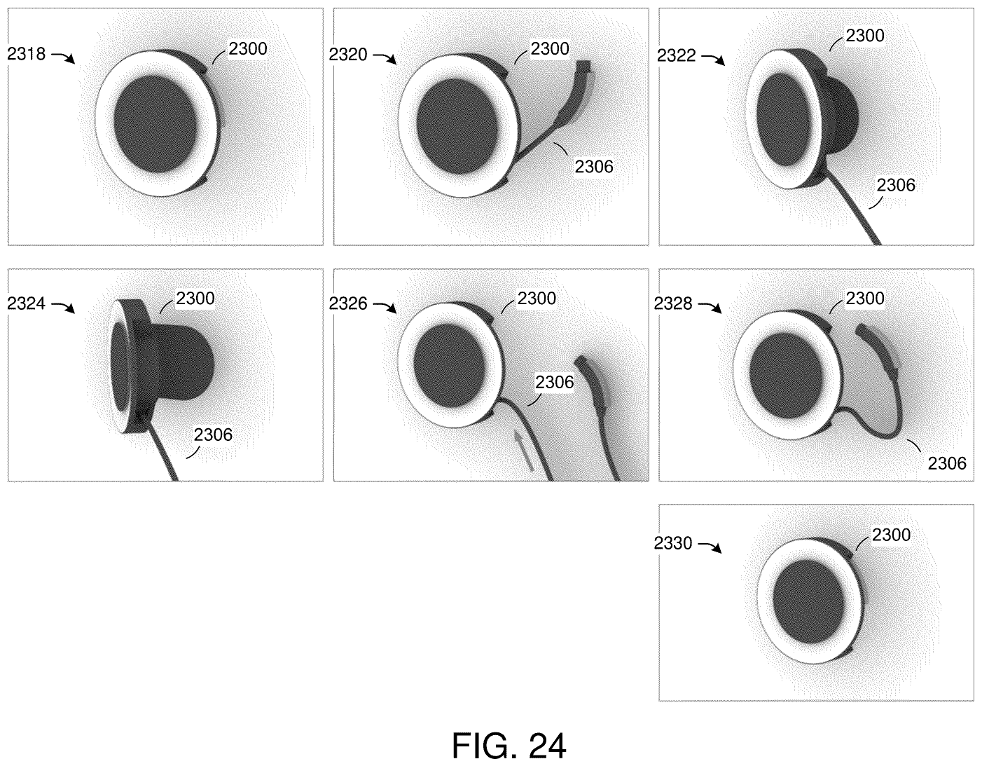

FIG. 24 illustrates an example EV charger retraction in accordance with one embodiment.

Referring to FIG. 24, the EV charger 2300 of FIG. 23 is shown in multiple positions. At position 2318, the EV charger 2300 is in a retracted position. At position 2320, the cable 2306 of the EV charger 2300 is shown as partially removed from the EV charger 2300. At position 2322, the cable 2306 is more extended, and at position 2324, the cable 2306 is even more extended. At position 2326, the cable 2306 is retracting. At position 2328, the cable 2306 is even further retracted. At position 2330, the cable 2306 is fully retracted.

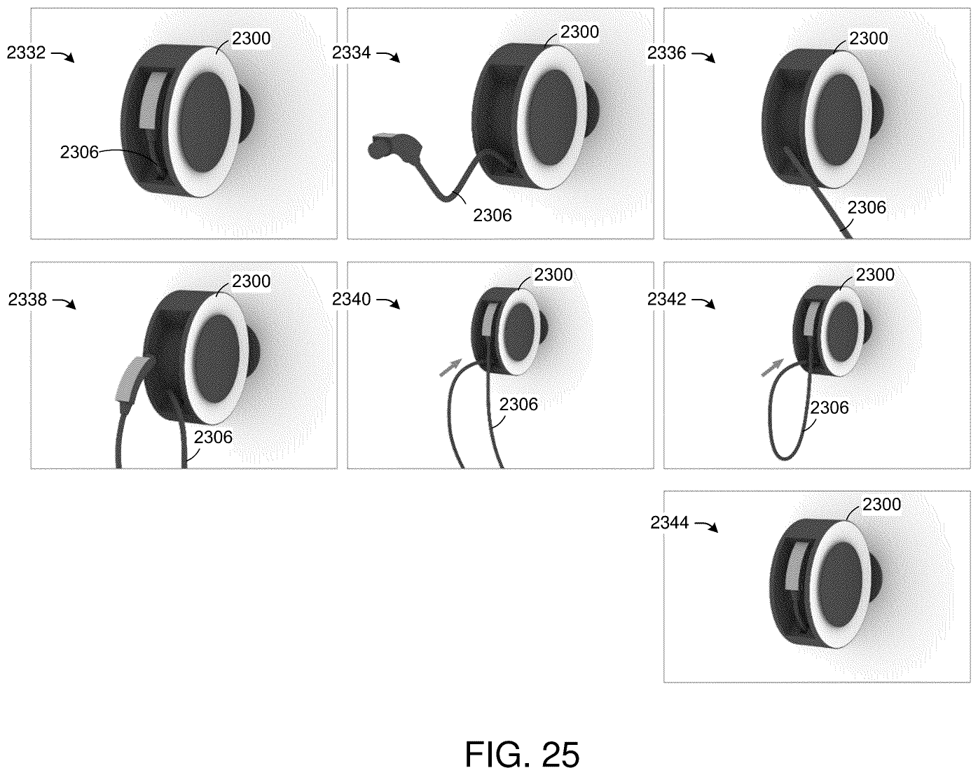

FIG. 25 illustrates an example EV charger retraction in accordance with one embodiment.

Referring to FIG. 25, the EV charger 2300 of FIG. 23 is shown in multiple positions. At position 2332, the EV charger 2300 is in a retracted position. At position 2334, the cable 2306 of the EV charger 2300 is shown as partially removed from the EV charger 2300. At position 2336, the cable 2306 is more extended, and at position 2338, the cable 2306 is even more extended. At position 2340, the cable 2306 is retracting. At position 2340, the cable 2306 is even further retracted. At position 2344, the cable 2306 is fully retracted.

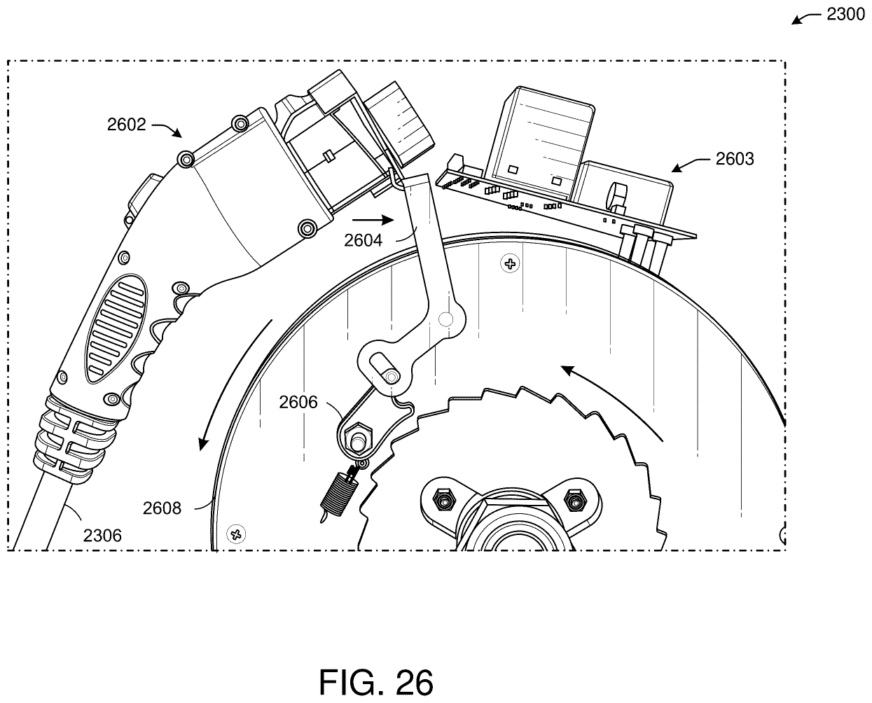

Referring to FIGS. 22-25, as the cable 2306 is pulled out, there may be minimal resistance in an internal spring (e.g., shown in FIG. 26) of the EV charger 2300, allowing the cable 2306 to be easily pulled to the power port of the EV 2300. When the cable 2306 is plugged back in, an internal motor (e.g., shown in FIG. 26) of the EV charger 2300 may wind the cable 2306 up slowly. Any amount of resistance may cause the motor to stop pulling until the resistance is removed, and which time the motor may continue to wind the cable 2306. To make the cable 2306 easier to pull out from the reel, the EV charging station 2300 may be mounted on a hinge with an internal spring that may allow the EV charging station 2300 to pivot away from the mounting wall. When the cable 2306 is returned (e.g., retracted), an internal spring may cause the EV charging station 2300 to hinge back to its original position. To make the cable 2306 easier to pull out of the reel, the EV charging station 2300 may be mounted 90 degrees to its mounted wall, allowing the reel to be oriented in line with the direction of the pull. When the cable 2306 is returned, the cord may hang loosely until the connector is plugged in, at which time an internal tooth may be released, allowing the cord reel to slowly wind up the cord.

FIG. 26 illustrates the EV charger 2300 for winding the cable 2306 of FIG. 23 in accordance with one embodiment.

Referring to FIG. 26, when a connector 2602 is plugged into the EV charging station 2300 charger 2603, an arm 2604 may unlock a spring 2606, causing the cable 2306 to be wound back onto the reel 2608. Rather than the arm 2604, the device may use an electric switch/solenoid (or some other means, not shown) to unlock the spring 2606. Alternatively, a motor (not shown) may wind up the cable 2306. The device may wait a period of time before winding after the connector 2602 is plugged in (e.g., in case the user decides to reconnect the connector 2602 to an EV) before winding the cable 2306.

FIG. 27 illustrates an example system 2700 for reserving and operating EV charging stations in accordance with one embodiment.

Referring to FIG. 27, the system 2700 may include devices 2702 with which a user may access the mobile application for identifying and reserving EV charging stations. The devices 2702 may include smart phones, tablets, laptops, wearable devices, in-vehicle devices, and the like. The system 2700 may include multiple EV charging banks in multiple locations (e.g., EV charging bank 2704, EV charging bank 2706, etc., which may represent the EV charging banks of FIGS. 4 and 6-18, and whose EV charging stations and chargers may represent the EV charger 2300 of FIG. 23). The devices 2702 and EV charging stations may communicate with one or more remote systems 2708 (e.g., cloud-based servers or other remote devices representing a management system), which may store the EV charging station data (e.g., location, availability, prices, etc.), vehicle data, user account data, and user interface data with which to present the mobile application (e.g., as shown in FIGS. 1 and 2). The EV charging banks may include their own respective gateways (e.g., software modules using processing circuitry for execution). For example, the EV charging bank 2704 may include a gateway 2710, and the EV charging bank 2706 may include a gateway 2712. The gateways 2710 and 2712 may collect charging data from the respective charging stations at the charging banks, and may send the charging data to the one or more remote systems 2708 to be used to present reservation data to the mobile application.

When the one or more remote systems 2708 receive requests from the mobile application to reserve an EV charging station at an EV charging bank, the one or more remote systems 2708 may send an indication of such request to the respective gateway of the charging bank controlling the reserved EV charger, including information about the user(s) allowed to use the reserved EV charging station, the start time, end time, and duration of the reservation, authorized accounts (e.g., tied to a user, vehicle, rewards account for a retailer, or the like), and whether a boost has been requested (e.g., a requested amount of power to provide to the reserved EV charging station). The gateway may receive the information from the one or more remote systems 2708 and send commands to its charging stations to increase and/or decrease power distributed by the charging stations (e.g., as described with respect to FIGS. 6-18).

The devices 2702 may provide their data to the one or more remote systems 2708 so that when the devices 2702 attempt to access the mobile application, the one or more remote systems 2708 may verify a user's account and vehicle, identify available charging stations and their prices, predict availability of charging station, and present options for reservations, charging boosts, and the like. The devices 2702 may be used to authenticate a user to an EV charging station and authorize use of the EV charging station at an EV charging bank (e.g., as shown in FIG. 5).

In one or more embodiments, the communication between the gateways 2710 and 2712 and the one or more remote devices 2708 may use the OCPP or another communication protocol.

In one or more embodiments, an EV charger reservation using the mobile application may be tied to a rewards account. For example, when the EV charging bank 2704 is at a retailer or hotel that offers a rewards account for users, the authorization to the EV charging station to unlock the EV charging station for use may represent an authorization of the rewards account used to make the reservation. In this manner, some EV charging banks and/or charging stations of a charging bank may be limited to rewards accounts at certain times.

In one or more embodiments, the one or more remote devices 2708 may be integrated with a residential/guest ledger (e.g., guestfolio at a hotel). In this manner, the EV charging may be linked to a user's bill for a hotel, apartment, or the like.

Some embodiments may be used in conjunction with one or more types of wireless communication signals and/or systems following one or more wireless communication protocols, for example, OCPP, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, sixth generation (6G) mobile networks, 3GPP, long term evolution (LTE), LTE advanced, enhanced data rates for GSM Evolution (EDGE), or the like. Other embodiments may be used in various other devices, systems, and/or networks. The communication between the devices 2702, the one or more remote systems 2708, the charging station 2704, and/or the charging station 2706 may use any of the communications networks and techniques described above.

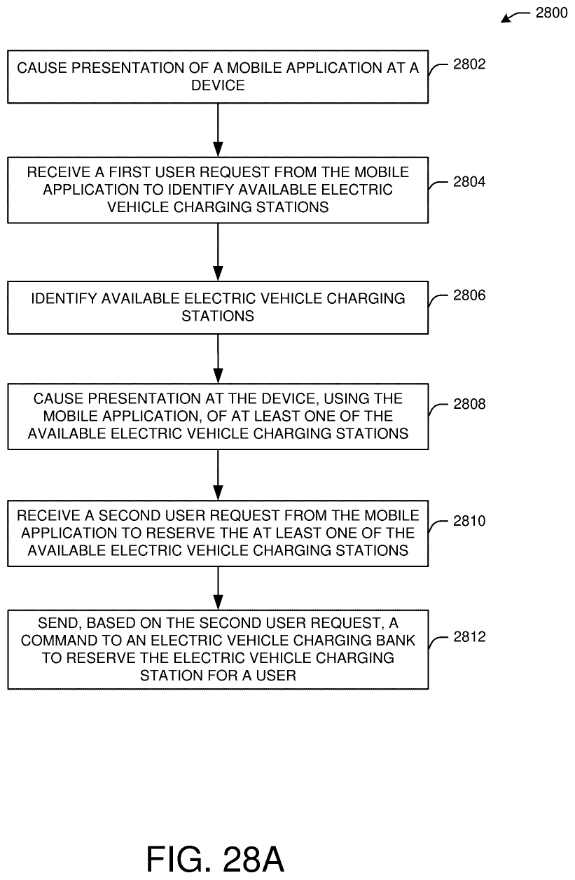

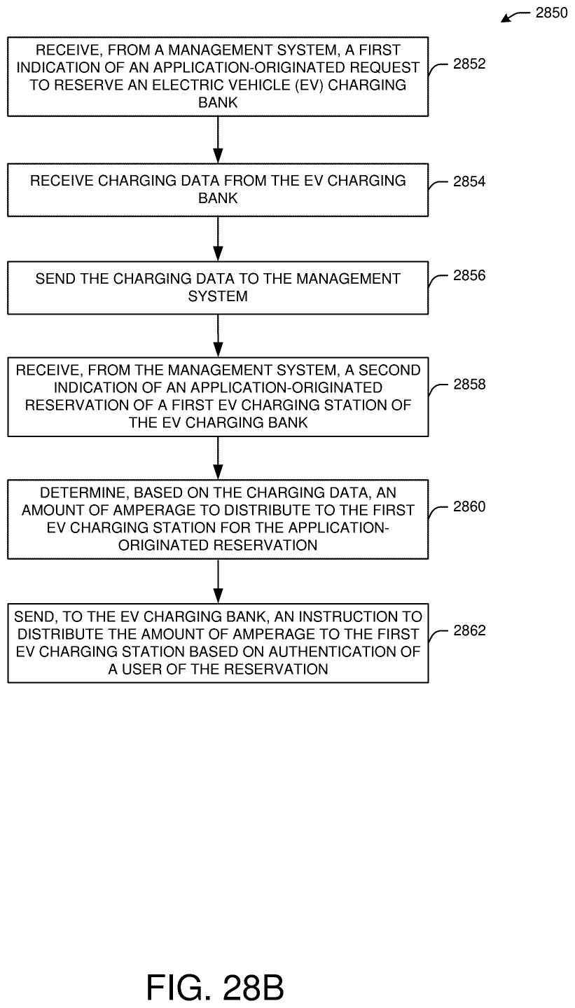

FIG. 28A is a flowchart illustrating a process 2800 for reserving and using an EV charging station in accordance with one embodiment.

At block 2802, a device (or system, e.g., the one or more remote systems 2708 of FIG. 27) may generate and send user interface data (e.g., as shown in FIGS. 1 and 2) of a mobile application for presentation at another device (e.g., the devices 2702 of FIG. 27). The mobile application may allow a user to identify available EV charging stations, reserve available EV charging stations, pay for EV charging station use, and other features described herein.

At block 2804, the device may receive a first user request from the mobile application on the second device to identify available electric vehicle charging stations. The user who provides the first user request may consent to providing device and/or EV location data so that the device may determine which EV charging stations are nearby and available, and/or which EV charging stations may be on a route of the vehicle, and/or which EV charging stations may be available at a later time.

At block 2806, the device may identify the available EV charging stations based on location data of the user and location and use data of the EV charging stations. The device may receive charging data from gateways of respective EV charging banks (e.g., the gateway 2710 of the charging bank 2704, the gateway 2712 of the charging bank 2706). The charging data may include information regarding which charging stations are being used and/or available, how long an EV charging station in use has been in use, the amps provided to the EV charging stations, which users and accounts have been authenticated to and authorized by the EV charging stations, and the like.

At block 2808, the device may cause the other device to present, using the mobile application, available EV charging stations as identified at block 2806.

At block 2810, the device may receive a second user request from the mobile application on the other device to reserve one of the EV charging stations at a particular location and time.

At block 2812, the device may reserve the selected EV charging station, based on the second user request, by sending a command to the selected EV charging bank to reserve a charging station for the user (e.g., identified by a user account and/or vehicle identifier). The EV charging bank may send commands to its charging stations to distribute the power (e.g., as described with respect to FIGS. 6-18).

FIG. 28B is a flowchart illustrating a process 2850 for reserving and using an EV charging station in accordance with one embodiment.

At block 2852, a device (or system, e.g., the gateway 2710 of FIG. 27) may receive, from a management system (e.g., the one or more remote systems 2708 of FIG. 27), a first indication of an application-originated request to reserve and EV charging bank. A user may use an application to communicate with the management system to search for and reserve EV charging banks. The device may communicate with its charging bank to retrieve information used to reserve and control the charging bank.

At block 2854, the device may receive charging data from the EV charging bank, such as which charging stations and the charging bank are in use or available, the amount of charge being provided to vehicles using the charging bank, and the like.

At block 2856, the device may send the charging data to the management system. In this manner, the device may not communicate directly with the user's device or application used to reserve the EV charging bank.

At block 2858, the device may receive, from the management system, a second indication of an application-originated reservation of a first EV charging station of the EV charging bank. For example, based on the charging data, the management system may present to a user device, via the application, available charging stations including the first EV charging station. When a user reserves the first EV charging station with the application, the reservation is facilitated by the management system and communicated to the device for control of the EV charging bank.

At block 2860, the device may determine, based on the charging data, an amount of amperage to distribute to the first EV charging station for the application-originated reservation. The amount of amperage may depend on the number of EV charging stations using the EV charging bank during the time of the reservation and the amount of amperage that the EV charging bank is capable of providing. The amount of amperage also may depend on whether the reservation and/or any other uses of the EV charging bank include a boost.

At block 2862, the device may send, to the EV charging bank, an instruction to distribute the amount of amperage to the first EV charging station based on authentication of the user of the reservation. When the user authenticates to the first charging station, the EV charging bank may control distribution of amperage to the EV using the first EV charging bank, and may adjust amperage provided to other EVs using the EV charging bank if needed.

It is understood that the above descriptions are for purposes of illustration and are not meant to be limiting.

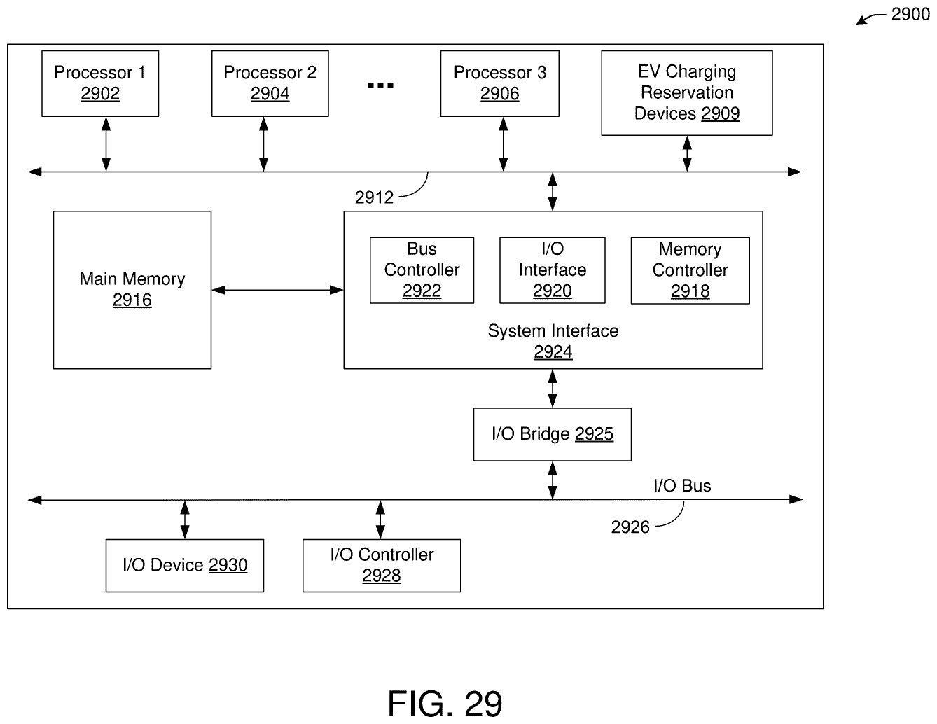

FIG. 29 is a block diagram illustrating an example of a computing device or computer system 2900 which may be used in implementing the embodiments of the components of the network disclosed above. For example, the computing system 2900 of FIG. 29 may represent at least a portion of the devices and systems shown in the figures and discussed above. The computer system (system) includes one or more processors 2902-2906, and one or more EV charging reservation devices 2909 (e.g., to facilitate the mobile application, EV charging estimates, EV charging reservations, EV charging payments, and/or EV current distribution control of the figures and description above). Processors 2902-2906 may include one or more internal levels of cache (not shown) and a bus controller 2922 or bus interface unit to direct interaction with the processor bus 2912. Processor bus 2912, also known as the host bus or the front side bus, may be used to couple the processors 2902-2906 with the system interface 2924. System interface 2924 may be connected to the processor bus 2912 to interface other components of the system 2900 with the processor bus 2912. For example, system interface 2924 may include a memory controller 2918 for interfacing a main memory 2916 with the processor bus 2912. The main memory 2916 typically includes one or more memory cards and a control circuit (not shown). System interface 2924 may also include an input/output (I/O) interface 2920 to interface one or more I/O bridges 2925 or I/O devices with the processor bus 2912. One or more I/O controllers and/or I/O devices may be connected with the I/O bus 2926, such as I/O controller 2928 and I/O device 2930, as illustrated.

I/O device 2930 may also include an input device (not shown), such as an alphanumeric input device, including alphanumeric and other keys for communicating information and/or command selections to the processors 2902-2906. Another type of user input device includes cursor control, such as a mouse, a trackball, or cursor direction keys for communicating direction information and command selections to the processors 2902-2906 and for controlling cursor movement on the display device.

System 2900 may include a dynamic storage device, referred to as main memory 2916, or a random access memory (RAM) or other computer-readable devices coupled to the processor bus 2912 for storing information and instructions to be executed by the processors 2902-2906. Main memory 2916 also may be used for storing temporary variables or other intermediate information during execution of instructions by the processors 2902-2906. System 2900 may include a read only memory (ROM) and/or other static storage device coupled to the processor bus 2912 for storing static information and instructions for the processors 2902-2906. The system outlined in FIG. 29 is but one possible example of a computer system that may employ or be configured in accordance with aspects of the present disclosure.

According to one embodiment, the above techniques may be performed by computer system 2900 in response to processor 2904 executing one or more sequences of one or more instructions contained in main memory 2916. These instructions may be read into main memory 2916 from another machine-readable medium, such as a storage device. Execution of the sequences of instructions contained in main memory 2916 may cause processors 2902-2906 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 2906 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 2916, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The following are example embodiments of the present disclosure and are not mean to be limiting.

Example 1 may include a method for reserving electric vehicle charging ports, the method comprising: causing presentation, by at least one processor of a first device, of a mobile application at a second device; receiving, by the at least one processor, a first user request from the mobile application to identify an available electric vehicle charging port of an electric vehicle charging station comprising multiple charging ports; identifying, by the at least one processor, a first available electric vehicle charging port; causing presentation, by the at least one processor, of an indication of the first available electric vehicle charging port at the second device, using the mobile application; receiving, by the at least one processor, a second user request from the mobile application to reserve the first available electric vehicle charging port; and sending, by the at least one processor, based on the second user request, a command to the electric vehicle charging station to reserve the first available electric vehicle charging port for a user from which the second user request was received.

Example 2 may include the method of example 1, further comprising: receiving, by the electric vehicle charging station, the command; and presenting, by electric vehicle charging station, based on the command, an indication that the first available electric vehicle charging port is reserved.

Example 3 may include the method of example 2, further comprising: receiving, by the electric vehicle charging station during the reservation, an indication of a user attempt to charge a first electric vehicle using the first available electric vehicle charging port; determining, by the electric vehicle charging station, that the user attempt was not made by the user or is unassociated with a second electric vehicle of the user; and preventing, by the first available electric vehicle charging port, distribution of current to the first electric vehicle via the first available electric vehicle charging port.

Example 4 may include the method of example 2, further comprising: receiving, by the electric vehicle charging station during the reservation, an indication of a user attempt to charge a first electric vehicle using the first available electric vehicle charging port; determining, by the electric vehicle charging station, that the user attempt was made by the user or is associated with the first electric vehicle of the user; and causing distribution, by the electric vehicle charging station, of current to the first electric vehicle via the first available electric vehicle charging port.

Example 5 the method of example 1, further comprising: determining that the first electric vehicle charging port is unavailable at a time when the second user request is received; and generating an estimated time when the first electric vehicle charging port is to be available, wherein the indication indicates the estimated time, and wherein the reservation begins at the estimated time.

Example 6 may include the method of example 1, further comprising: generating, based on a battery status of an electric vehicle associated with the user, an estimated time duration needed to fully charge a battery of the electric vehicle.

Example 7 may include the method of example 6, wherein the estimated time is based on a number of electric vehicles estimated to be using the multiple charging ports of the electric vehicle charging station when the electric vehicle is estimated to arrive at the electric vehicle charging station.

Example 8 may include the method of example 1, further comprising: detecting, by the electric vehicle charging station, a number of electric vehicles connected to the multiple charging ports of the electric vehicle charging station; determining, by the electric vehicle charging station, a power distribution for each of the connected electric vehicles based on an available current; and causing distribution, by the electric vehicle charging station, of current to the connected electric vehicles based on the power distribution.

Example 9 may include the method of example 1, further comprising: receiving a third user request from the mobile application to distribute more current to a first electric vehicle of the user while charging the first electric vehicle than to a second electric vehicle while the first electric vehicle is charging.

Example 10 may include the method of example 9, further comprising: reducing, by the electric vehicle charging station, current distributed to the second electric vehicle while the first electric vehicle is charging.

Example 11 may include a system for reserving electric vehicle charging ports, the system comprising: electric vehicle charging stations each comprising multiple charging ports; and memory coupled to at least one processor of a first device, the at least one processor configured to: cause presentation of a mobile application at a second device; receive a first user request from the mobile application to identify an available electric vehicle charging port of the electric vehicle charging stations; identify a first available electric vehicle charging port of the electric vehicle charging stations; cause presentation of an indication of the first available electric vehicle charging port at the second device, using the mobile application; receive a second user request from the mobile application to reserve the first available electric vehicle charging port; and send, based on the second user request, a command to an electric vehicle charging station comprising the first available electric vehicle charging port to reserve the first available electric vehicle charging port for a user from which the second user request was received.

Example 12 may include the system of example 11, wherein the electric vehicle charging station is configured to: receive the command; and present, based on the command, an indication that the first available electric vehicle charging port is reserved.

Example 13 may include the system of example 12, wherein the electric vehicle charging station is further configured to: receive, during the reservation, an indication of a user attempt to charge a first electric vehicle using the first available electric vehicle charging port; determine that the user attempt was not made by the user or is unassociated with a second electric vehicle of the user; and prevent distribution of current to the first electric vehicle via the first available electric vehicle charging port.

Example 14 may include the system of example 12, wherein the electric vehicle charging station is further configured to: receive, during the reservation, an indication of a user attempt to charge a first electric vehicle using the first available electric vehicle charging port; determine that the user attempt was made by the user or is associated with the first electric vehicle of the user; and cause distribution of current to the first electric vehicle via the first available electric vehicle charging port.

Example 15 may include the system of example 11, wherein the at least one processor is further configured to: determine that the first electric vehicle charging port is unavailable at a time when the second user request is received; and generate an estimated time when the first electric vehicle charging port is to be available, wherein the indication indicates the estimated time, and wherein the reservation begins at the estimated time.

Example 16 may include the system of example 11, wherein the at least one processor is further configured to: generating, based on a battery status of an electric vehicle associated with the user, an estimated time duration needed to fully charge a battery of the electric vehicle.

Example 17 may include the system of example 16, wherein the estimated time is based on a number of electric vehicles estimated to be using the vehicle charging station when the electric vehicle is estimated to arrive at the electric vehicle charging station.

Example 18 may include the system of example 11, wherein the electric vehicle charging station is further configured to: detect a number of electric vehicles connected to charging ports of the electric vehicle charging station; determine a power distribution for each of the connected electric vehicles based on an available current; and cause distribution of current to the connected electric vehicles via the charging ports based on the power distribution.

Example 19 may include the system of example 18, wherein the at least one processor is further configured to: receive a third user request from the mobile application to distribute more current to a first electric vehicle of the user while charging the first electric vehicle than to a second electric vehicle while the first electric vehicle is charging.

Example 20 may include the system of example 19, wherein the electric vehicle charging station is further configured to: reduce current distributed to the second electric vehicle while the first electric vehicle is charging.

Example 21 may include a device for reserving electric vehicle charging ports, the device comprising memory coupled to at least one processor of a device, the at least one processor configured to: cause presentation of a mobile application at a second device; receive a first user request from the mobile application to identify an available electric vehicle charging port; identify a first available electric vehicle charging port of an electric vehicle charging station comprising multiple charging ports; cause presentation of an indication of the first available electric vehicle charging port at the second device, using the mobile application; receive a second user request from the mobile application to reserve the first available electric vehicle charging port; and send, based on the second user request, a command to the electric vehicle charging station to reserve the first available electric vehicle charging port for a user from which the second user request was received.

Example 22 may include the device of example 21, wherein at least one processor of the electric vehicle charging station is configured to: receive the command; and present, based on the command, an indication that the first available electric vehicle charging port is reserved.

Example 23 may include the device of example 22, wherein the at least one processor of the electric vehicle charging station is configured to: receive, during the reservation, an indication of a user attempt to charge a first electric vehicle using the first available electric vehicle charging port; determine that the user attempt was not made by the user or is unassociated with a second electric vehicle of the user; and prevent distribution of current to the first electric vehicle via the first available electric vehicle charging port.

Example 24 may include the device of example 22, wherein the at least one processor of the electric vehicle charging station is configured to: receive, during the reservation, an indication of a user attempt to charge a first electric vehicle using the first available electric vehicle charging port; determine that the user attempt was made by the user or is associated with the first electric vehicle of the user; and cause distribution of current to the first electric vehicle via the first available electric vehicle charging port.

Example 25 may include the device of example 21, wherein the at least one processor is further configured to: determine that the first available electric vehicle charging port is unavailable at a time when the second user request is received; and generate an estimated time when the first available electric vehicle charging port is to be available, wherein the indication indicates the estimated time, and wherein the reservation begins at the estimated time.

Example 26 may include the device of example 21, wherein the at least one processor is further configured to: generate, based on a battery status of an electric vehicle associated with the user, an estimated time duration needed to fully charge a battery of the electric vehicle.

Example 27 may include the device of example 26, wherein the at least one processor is further configured to, wherein the estimated time is based on a number of electric vehicles estimated to be using the electric vehicle charging station when the electric vehicle is estimated to arrive at the electric vehicle charging station.

Example 28 may include the device of example 21, wherein at least one processor of the electric vehicle charging station is configured to: detect a number of electric vehicles connected to the multiple charging ports of the electric vehicle charging station; determine a power distribution for each of the connected electric vehicles based on an available current; and cause distribution of current to the connected electric vehicles based on the power distribution.

Example 29 may include the device of example 21, wherein the at least one processor is further configured to: receive a third user request from the mobile application to distribute more current to a first electric vehicle of the user while charging the first electric vehicle than to a second electric vehicle while the first electric vehicle is charging.

Example 30 may include the device of example 29, wherein at least one processor of the first available electric vehicle charging station is configured to: reduce current distributed to the second electric vehicle while the first electric vehicle is charging.

Example 31 may include a method for distributing power to multiple electrical vehicles using charging ports at a charging station, the method comprising: detecting a number of electrical vehicles concurrently connected to charging ports of a charging station, wherein the charging ports are serially connected; dividing an available amperage of the charging station by the number of electrical vehicles to generate a first respective amperage to distribute to each of the electrical vehicles via the charging ports; identifying a user request to boost the first respective amperage distributed to a first electrical vehicle of the number of electrical vehicles, via a first charging port of the charging ports, to a first amperage above the first respective amperage; subtracting the first amperage from the available amperage to generate a remaining available amperage in addition to the first amperage; dividing the remaining available amperage of the charging station by the number of electrical vehicles minus the first electrical vehicle to generate a second respective amperage to distribute to each of the electrical vehicles, except the first electrical vehicle, via the charging ports except for the first charging port; and distributing the first amperage to the first charging port while distributing the second respective amperage to the charging ports except for the first charging port.

Example 32 may include a retractable electrical vehicle charging device, wherein a cable of the retractable electrical vehicle charging device is configured to retract while a button on a handle of the retractable electrical vehicle charging device is pressed.

Example 33 may include a retractable electrical vehicle charging device, wherein a cable of the retractable electrical vehicle charging device is configured to retract when a handle of the retractable electrical vehicle charging device is docked.

Example 34 may include a retractable electrical vehicle charging device comprising a sensor and at least one processor, wherein the at least one processor is configured to: detect when a handle of the retractable electrical vehicle charging device has not been connected to a vehicle for a period of time; and cause a cable of the retractable electrical vehicle charging device to retract based on the detection.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

1. A method for reserving electric vehicle charging ports, the method comprising:
receiving, by at least one processor of an electric vehicle charging bank, from a management system, a first indication of an application-originated request to reserve the electric vehicle charging bank;
receiving, by the at least one processor, charging data from the electric vehicle charging bank, wherein the charging data indicate that a first electric vehicle charging station of the electric vehicle charging bank is available for charging an electric vehicle;
sending, by the at least one processor, to the management system, the charging data;
receiving, by the at least one processor, from the management system, a second indication of an application-originated reservation of the first electric vehicle charging station;
determining, by the at least one processor, based on the charging data, an amount of amperage to distribute to the first electric vehicle charging station for the application-originated reservation; and
send, by the at least one processor, to the electric vehicle charging bank, an instruction to distribute the amount of amperage to the first electric vehicle charging station based on authentication of a user of the reservation.

2. The method of claim 1, wherein:
the charging data indicate that no other electric vehicles are using or have reserved the electric vehicle charging bank during the application-originated reservation of the first electric vehicle charging station, and
wherein the amount of amperage is 40 amps.

3. The method of claim 1, wherein:
the charging data indicate that at least one other electric vehicle is using or has reserved the electric vehicle charging bank during the application-originated reservation of the first electric vehicle charging station, and
wherein the amount of amperage is 40 amps.

4. The method of claim 1, wherein:
the charging data indicate that at least one other electric vehicle is using or has reserved the electric vehicle charging bank during the application-originated reservation of the first electric vehicle charging station, and
wherein the amount of amperage is less than 40 amps.

5. The method of claim 4, further comprising:
sending, to the electric vehicle charging bank, a second instruction to reduce a second amount of amperage distributed to the at least one other electric vehicle, wherein the second amount of amperage is greater than zero.

6. The method of claim 5, wherein application-originated reservation comprises a request to provide more amperage to the first electric vehicle than to the at least one other electric vehicle, and wherein the amount of amperage is 40 amps.

7. The method of claim 6, further comprising:
receiving, from the electric vehicle charging bank, a third indication that charging has completed at the first electric vehicle charging station; and
sending, to the electric vehicle charging bank, based on the charging being completed at the first electric vehicle charging station, a third instruction to increase the second amount of amperage distributed to the at least one other electric vehicle.

8. The method of claim 1, wherein the first indication, the charging data, and the second indication are sent using an Open Charge Point Protocol.

9. The method of claim 1, wherein the application-originated reservation of the first electric vehicle charging station comprises a start time of the application-originated reservation, and wherein the instruction comprises a third indication of the start time.

10. The method of claim 1, wherein the application-originated reservation of the first electric vehicle charging station comprises a third indication of a user associated with authenticating the application-originated reservation, and wherein the application-originated reservation is associated with authorizing use of only the first electric vehicle charging station at the electric vehicle charging bank.

11. The method of claim 1, wherein the application-originated reservation of the first electric vehicle charging station comprises multiple users authorized to use the first electric vehicle charging station at the electric vehicle charging bank during the application-originated reservation.

12. A device of an electric vehicle charging bank, the device comprising memory coupled to at least one processor, the at least one processor configured to:
receive, from a management system, a first indication of an application-originated request to reserve the electric vehicle charging bank;
receive charging data from the electric vehicle charging bank, wherein the charging data indicate that a first electric vehicle charging station of the electric vehicle charging bank is available for charging an electric vehicle;
send, to the management system, the charging data;
receive, from the management system, a second indication of an application-originated reservation of the first electric vehicle charging station;
determine, based on the charging data, an amount of amperage to distribute to the first electric vehicle charging station for the application-originated reservation; and
send, to the electric vehicle charging bank, an instruction to distribute the amount of amperage to the first electric vehicle charging station based on authentication of a user of the application-originated reservation.

13. The device of claim 12, wherein:
the charging data indicate that no other electric vehicles are using or have reserved the electric vehicle charging bank during the application-originated reservation of the first electric vehicle charging station, and
wherein the amount of amperage is 40 amps.

14. The device of claim 12, wherein:
the charging data indicate that at least one other electric vehicle is using or has reserved the electric vehicle charging bank during the application-originated reservation of the first electric vehicle charging station, and
wherein the amount of amperage is 40 amps.

15. The device of claim 12, wherein:
the charging data indicate that at least one other electric vehicle is using or has reserved the electric vehicle charging bank during the application-originated reservation of the first electric vehicle charging station, and
wherein the amount of amperage is less than 40 amps.

16. The device of claim 15, wherein the at least one processor is further configured to:
send, to the electric vehicle charging bank, a second instruction to reduce a second amount of amperage distributed to the at least one other electric vehicle, wherein the second amount of amperage is greater than zero.

17. The device of claim 15, wherein application-originated reservation comprises a request to provide more amperage to the electric vehicle than to the at least one other electric vehicle, and wherein the amount of amperage is 40 amps.

18. The device of claim 16, wherein the at least one processor is further configured to:
receive, from the electric vehicle charging bank, a third indication that charging has completed at the first electric vehicle charging station; and
send, to the electric vehicle charging bank, based on the charging being completed at the first electric vehicle charging station, a third instruction to increase the second amount of amperage distributed to the at least one other electric vehicle.

19. The device of claim 12, wherein the first indication, the charging data, and the second indication are sent using an Open Charge Point Protocol.

20. The device of claim 12, wherein the application-originated reservation of the first electric vehicle charging station comprises a start time of the application-originated reservation, and wherein the instruction comprises a third indication of the start time.

21. The device of claim 12, wherein the application-originated reservation of the first electric vehicle charging station comprises a third indication of a user associated with authenticating the application-originated reservation, and wherein the application-originated reservation is associated with authorizing use of only the first electric vehicle charging station at the electric vehicle charging bank.

22. The device of claim 12, wherein the application-originated reservation of the first electric vehicle charging station comprises multiple users authorized to use the first electric vehicle charging station at the electric vehicle charging bank during the application-originated reservation.

23. A system for reserving electric vehicle charging ports, the system comprising:
a management system configured to reserve electric vehicle charging ports of electric vehicle charging banks; and
a device of a first electric vehicle charging bank of the electric vehicle charging banks,
wherein the device of the first electric vehicle charging bank is configured to:
receive, from the management system, a first indication of an application-originated request to reserve the electric vehicle charging bank;
receive charging data from the electric vehicle charging bank, wherein the charging data indicate that a first electric vehicle charging station of the electric vehicle charging bank is available for charging an electric vehicle;
send, to the management system, the charging data;
receive, from the management system, a second indication of an application-originated reservation of the first electric vehicle charging station;
determine, based on the charging data, an amount of amperage to distribute to the first electric vehicle charging station for the application-originated reservation; and
send, to the electric vehicle charging bank, an instruction to distribute the amount of amperage to the first electric vehicle charging station based on authentication of a user of the reservation.

24. The system of claim 23, wherein the management system is further configured to:
receive, from a mobile application, the application-originated request to reserve the electric vehicle charging station;
receive the charging data from the device of the first electric vehicle charging bank;
determine, based on the charging data, that the first electric vehicle charging station is available for charging the electric vehicle;
send, to the mobile application, graphical data comprising electrical vehicle charging stations available for charging the electric vehicle, the electrical vehicle charging stations comprising the first electric vehicle charging station;
receive, from the mobile application, the application-originated reservation of the first electric vehicle charging station;
send, to the device of the first electric vehicle charging bank, the second indication of the application-originated reservation of the first electric vehicle charging station; and
send, to the mobile application, a confirmation of the application-originated reservation of the first electric vehicle charging station, the confirmation comprising an estimated amount of time needed to complete charging of the electric vehicle.

25. The system of claim 23, wherein:
the charging data indicate that no other electric vehicles are using or have reserved the electric vehicle charging station during the application-originated reservation of the first electric vehicle charging station, and
wherein the amount of amperage is 40 amps.

26. The system of claim 23, wherein:
the charging data indicate that at least one other electric vehicle is using or has reserved the electric vehicle charging station during the application-originated reservation of the first electric vehicle charging station, and
wherein the amount of amperage is 40 amps.

27. The system of claim 23, wherein:
the charging data indicate that at least one other electric vehicle is using or has reserved the electric vehicle charging station during the application-originated reservation of the first electric vehicle charging station, and
wherein the amount of amperage is less than 40 amps.

28. The system of claim 27, wherein the device of the electrical vehicle charging bank is further configured to:
send, to the electric vehicle charging station, a second instruction to reduce a second amount of amperage distributed to the at least one other electric vehicle, wherein the second amount of amperage is greater than zero.

29. The system of claim 27, wherein application-originated reservation comprises a request to provide more amperage to the electric vehicle than to the at least one other electric vehicle, and wherein the amount of amperage is 40 amps.

30. The system of claim 28, wherein the device of the electrical vehicle charging bank is further configured to:
receive, from the electric vehicle charging bank, a third indication that charging has completed at the first electric vehicle charging station; and
send, to the electric vehicle charging station, based on the charging being completed at the first electric vehicle charging station, a third instruction to increase the second amount of amperage distributed to the at least one other electric vehicle.

31. (canceled)

32. (canceled)

33. (canceled)

34. (canceled)
